(19) United States
(12) Patent Application Publication
(10) Pub. No.: US 2016/0183295 A1
(43) Pub. Date: Jun. 23, 2016

(54) Random Access Channel Resource Allocation Method and System

(71) Applicant: ZTE CORPORATION, Guangdong (CN)

(72) Inventors: Kun LIU, Shenzhen (CN); Bo DAI, Shenzhen (CN); Zhaohua LU, Shenzhen (CN); Shuqiang XIA, Shenzhen (CN); Huiying FANG, Shenzhen (CN); Jing SHI, Shenzhen (CN); Xincai LI, Shenzhen (CN)

(73) Assignee: ZTE CORPORATION, Shenzhen City, Guangdong Province (CN)

(21) Appl. No.: 14/910,254

(22) PCT Filed: May 26, 2014
(86) PCT No.: PCT/CN2014/000531

§ 371 Date: Feb. 5, 2016

(30) Foreign Application Priority Data
Aug. 9, 2013 (CN) 201310349543.X

(51) Int. Cl. H04W 74/00; H04W 72/04; H04W 74/08

(52) U.S. Cl. CPC H04W 74/002; H04W 74/0833; H04W 72/0446; H04W 72/0453

(57) ABSTRACT

A method and system for configuring random access channel resources are disclosed, which relates to the field of communication and solves the problem of access of the MTC UE in LTE/LET-A systems. The method includes: first nodes sending random access channel resource configuration information to second nodes, wherein the random access channel resource configuration information is indicated by one or a plurality of pieces of random access channel configuration information. The technical scheme provided by the embodiment of the present invention is applicable to LTE/LTE-A networks, thereby implementing the random access channel resource configuration of the MTC UE in the LTE/LTE-A systems.

### TECHNICAL FIELD

The present document relates to the field of communication, and more particularly, to a method and system for configuring random access channel resources.

### BACKGROUND OF THE RELATED ART

The Machine Type Communication (MTC) User Equipment (MTC UE), also called a Machine to Machine (M2M) user communication device, is a main application form of the Internet of Things at the present stage. Low power consumption and low cost are the important guarantee for large-scale application of the MTC UE. M2M devices deployed in the market at present are mainly based on Global System of Mobile communication (GSM) systems. In recent years, due to the improvement of spectral efficiency of Long Term Evolution (LTE)/Long Term Evolution-Advanced (LTE-A), more and more mobile operators choose the LTE/LTE-A as an evolution direction of broadband wireless communication systems in the future. Multiple-type LTE/LTE-A-based M2M data services will be more attractive. Only when the cost of the LTE-M2M devices is lower than that of the MTC terminal of the GSM systems, can the M2M services be truly switched from the GSM systems to the LTE systems.

At present, main alternative methods for decreasing the cost of the MTC user terminal include: reducing the number of receiving antennas of the terminal, decreasing the baseband processing bandwidth of the terminal, decreasing the peak rate supported by the terminal, and utilizing a half-duplex mode, etc. Although the decrease of the cost means the decrease of performance, the demand for coverage of cells of the LTE/LET-A systems cannot be decreased, thus an MTC terminal configured with low cost needs adoption of some measures so as to meet the demand for coverage performance of the existing LTE terminal. In addition, the MTC terminal may be located in places such as a basement and corners of wall, and the like, and the located scene is worse than that for a common LTE UE. In order to make up for the decreased coverage resulted from the penetration loss, part of the MTC UEs need higher performance improvement, thus it is necessary to improve the uplink and downlink coverage for the part of the MTC UEs with respect to the scenario. How to ensure the access quality of users is a problem required to be considered firstly, so it is necessary to make an improvement design for the Physical Random Access Channel (PRACH) of the LTE/LTE-A systems to ensure that the MTC UE can access the systems normally.

Position information of time-frequency resources occupied by the random access response (RAR) message in the LTE/LTE-A systems is contained in Downlink Control Information (DCI) and is sent through the Physical Downlink Control Channel (PDCCH). Additionally, the Cyclic Redundancy Check (CRC) of 16 bits is also contained in the DCI information described above, and the above CRC is further scrambled by using a Random Access Radio Network Temporary Identity (RA-RNTI) of 16 bits, and the scrambling manner is:

cₖ+(bₖ+aₖ)mod 2k=0,1, . . . , 15.

Wherein, bₖ is the (k+1)th bit in the CRC; aₖ is the (k+1)th bit in the RA-RNTI; and cₖ is the (k+1)th bit generated after the scrambling.

Since the improvement design is made for the Physical Random Access Channel (PRACH) of the LTE/LTE-A systems to ensure that the MTC UE can access the systems normally, the improvement design for the Random Access Response (RAR) message of the LTE/LTE-A systems is also required to ensure that the MTC UE can perform receiving normally.

### CONTENT OF THE INVENTION

The present document provides a method and system for configuring random access channel resources so as to solve the problem of access of an MTC UE in LTE/LET-A systems.

A method for configuring random access channel resources comprises:

first nodes sending random access channel resource configuration information to second nodes, wherein the random access channel resource configuration information is indicated by one or a plurality of pieces of random access channel configuration information.

Preferably, configuration information of first resources is at least comprised in the random access channel configuration information, the first resources are one of the following:

resources used for sending random access signalings and allocated to the second nodes; and

starting resources used for sending the random access signalings and allocated to the second nodes.

Preferably, the first resources occupy one or a plurality of first time domain measurement units in a time domain and occupy one or a plurality of first frequency domain measurement units in a frequency domain.

Preferably, the first time domain measurement unit is one of the following:

a Frame, a Ssubframe, a half frame, a time slot, an OFDM symbol, a physical resource block (PRB) and a physical resource block group.

Preferably, the first frequency domain measurement unit is one of the following:

a subcarrier, a physical resource block (PRB) and a physical resource block group.

Preferably, the configuration information of the first resources comprises at least one of the following:

configuration index information of the first resources; and

frequency domain offset information of the first resources.

Preferably, the configuration index information of the first resources indicates any one or a plurality of pieces of the following information:

within a predefined time domain period, time domain position distribution information occupied by the first resources within the predefined time domain period, wherein the predefined time domain period is described by using the first time domain measurement units and is configured by a system or sent by the first nodes;

quantity information of the first resources within a predefined time domain period, wherein the predefined time domain period is described by using the first time domain measurement units and is configured by a system or sent by the first nodes;

format information of the random access signalings;

information of whether the first resources support frequency hopping; and

frequency hopping pattern information of the first resources.

Preferably, being configured by the system means being configured by a standard or by a network or by a network upper layer.

Preferably, position information of the first resources in the frequency domain is determined by the frequency domain offset information of the first resources.

Preferably, position information of the first resources in the frequency domain is at least one of the following:

information of a starting resource position of the first resources in the frequency domain;

information of an end resource position of the first resources in the frequency domain; and

information of an occupied resource position of the first resources in the frequency domain.

Preferably, the information of the starting resource position, the information of the end resource position and the information of the occupied resource position are measured by using the first frequency domain measurement units.

Preferably, frequency domain position distribution information of the first resources is determined by the frequency domain offset information of the first resources and the configuration index information of the first resources.

Preferably, there are a plurality of positions of the first resources in the frequency domain.

Preferably, positions of a plurality of the first resources in a same time domain position are different in the frequency domain.

Preferably, the random access channel configuration information further comprises: frequency domain position distribution spacing information of the first resources.

Preferably, the frequency domain position distribution information of the first resources is determined by the frequency domain offset information of the first resources, the frequency domain position distribution spacing information of the first resources and the configuration index information of the first resources.

Preferably, when the random access channel resource configuration information is indicated by the plurality of random access channel configuration information, the configuration information of the first resources comprised in each piece of the random access channel configuration information is different.

Preferably, the random access channel resources are divided into one or a plurality of random access channel resource subsets, the random access channel resources are multiplexed between the random access channel resource subsets by means of time division multiplexing and/or frequency division multiplexing and/or code division multiplexing.

Preferably, when the random access channel resources are multiplexed between the random access channel resource subsets by means of time division multiplexing,

first resources whose time domain positions are within a predefined time domain set in the first resources are allocated to a random access channel resource subset; or,

first resources whose time domain positions are within a predefined time domain set and which have same frequency domain positions in the first resources are allocated to a random access channel resource subset; or,

first resources whose time domain positions are within a predefined time domain set and which are at predefined frequency domain positions in the first resources are allocated to a random access channel resource subset.

Preferably, the predefined time domain set comprises one or a plurality of time domain time points, and the time domain time points are measured by the first time domain measurement units, the one or the plurality of time domain time points are distributed continuously or discretely in the time domain.

Preferably, the predefined frequency domain positions are required to meet the following conditions:

frequency domain positions of the first resources on two adjacent time domain time points are different; and/or,

there are N different types of frequency domain positions among the predefined frequency domain positions, and the predefined time domain set is divided into N subsets, the frequency domain positions of the first resources in each subset correspond to one of the predefined frequency domain positions, N is an integer greater than or equal to 1.

Preferably, when the random access channel resources are multiplexed between the random access channel resource subsets by means of frequency division multiplexing,

first resources whose frequency domain positions are within a predefined frequency domain set in the first resources are allocated to a random access channel resource subset; or,

first resources whose frequency domain positions are within a predefined frequency domain set and which are at predefined time domain positions in the first resources are allocated to a random access channel resource subset.

Preferably, the predefined frequency domain set comprises one or a plurality of frequency domain points, and the frequency domain points are measured by the first frequency domain measurement units, the one or the plurality of frequency domain points are distributed continuously or discretely in the frequency domain.

Preferably, the predefined time domain positions comprise one or a plurality of time domain time points, and the time domain time points are measured by the first time domain measurement units, the one or the plurality of time domain time points are distributed continuously or discretely in the time domain.

Preferably, when the random access channel resources are multiplexed between the random access channel resource subsets by means of time division multiplexing and frequency division multiplexing, the first resources within a predefined set are allocated to a random access channel resource subset.

Preferably, elements in the predefined set are one or a plurality of sequenced first resources.

Preferably, an sequencing rule of the first resources is configured by the system.

Preferably, when the random access channel resources are multiplexed between the random access channel resource subsets by means of code division multiplexing,

a random access channel resource subset is formed from at least one predefined random access sequence set.

Preferably, one or a plurality of random access sequences are contained in the predefined random access sequence set.

Preferably, the random access channel resource subset supports one type or a plurality of types of the second nodes transmitting the random access sequences.

Preferably, the types of the second nodes are divided according to one of the following principles:

coverage improvement levels required to be supported by the second nodes;

the number of repeated transmissions of the random access sequences required to be supported by the second nodes,

repeat times of a physical broadcast channel (PBCH) used when the PBCH is decoded successfully by the second nodes,

repeat times of a master information block (MIB) message when the MIB message is decoded successfully by the second nodes,

repeat times of a system information block (SIB) message when the SIB message is decoded successfully by the second nodes, and

repeat times of the MIB message when the PBCH is decoded successfully by the second nodes.

Preferably, the second nodes are one or a plurality of terminals or one or a plurality of terminal groups.

Preferably, the first nodes are at least one of the following:
a Macrocell, a Microcell, a Picocell, a Femtocell, a low power node (LPN), aRrelay and a Small Cell.

Preferably, after the step of the first nodes sending the random access channel resource configuration information to the second nodes, the method further comprises:

the second nodes determining corresponding random access channel resources according to the random access channel configuration information and sending random access signalings to the first nodes by using the random access channel resources.

Preferably, after the step of the second nodes determining the corresponding random access channel resources according to the random access channel configuration information and sending the random access signalings to the first nodes by using the random access channel resources, the method further comprises:

the first nodes sending random access response signalings to the second nodes to respond to the random access signalings sent by the second nodes.

Preferably, random access response information of one or a plurality of the second nodes is carried in the random access response signalings.

Preferably, the one or the plurality of the second nodes are configured by the system or the first nodes.

Preferably, the one or the plurality of the second nodes have any one or a plurality of the following properties:

the one or the plurality of the second nodes belong to the same type,

coverage improvement levels required to be supported by the one or the plurality of the second nodes are same,

the number of repeated transmissions of the random access sequences required to be supported by the one or the plurality of the second nodes are same, and

RA-RNTIs calculated by the one or the plurality of the second nodes are same.

Preferably, the types of the one or the plurality of the second nodes are configured by the system;

the coverage improvement levels required to be supported by the one or the plurality of the second nodes are configured by the system; and

the number of the repeated transmissions of the random access sequences required to be supported by the one or the plurality of the second nodes are configured by the system.

Preferably, information of the number of repeated transmissions of the random access response signalings is indicated by the first nodes.

Preferably, the first nodes indicate the information of the number of repeated transmissions of the random access response signalings in at least one of the following manners:

indicating the information of the number of repeated transmissions of the random access response signalings in downlink control information;

a mapping relationship existing between information of maximum repeat times supported by a PBCH sent by the first nodes and the information of the number of repeated transmissions of the random access response signalings;

a mapping relationship existing between information of maximum repeat times supported by MIB information sent by the first nodes and the information of the number of repeated transmissions of the random access response signalings;

a mapping relationship existing between information of maximum repeat times supported by SIB information sent by the first nodes and the information of the number of repeated transmissions of the random access response signalings;

a mapping relationship existing between information of repeat times supported by the PBCH and the information of the number of repeated transmissions of the random access response signalings;

a mapping relationship existing between information of repeat times supported by the MIB and the information of the number of repeated transmissions of the random access response signalings; and

a mapping relationship existing between information of repeat times supported by the SIB and the information of the number of repeated transmissions of the random access response signalings.

Preferably, the information of the number of repeated transmissions of the random access response signalings is indicated by the types of the second nodes or the coverage improvement levels or the supported number of repeated transmissions of the random access sequences.

The present document further provides a system for allocating random access channel resources, which comprises first nodes and second nodes;

the first nodes are configured to: send random access channel resource configuration information to the second nodes, wherein the random access channel resource configuration information contains indications of one or a plurality of pieces of random access channel configuration information.

Preferably, the second nodes are one or a plurality of terminals or one or a plurality of terminal groups.

Preferably, the first nodes are at least one of the following:
a Macrocell, a Microcell, a Picocell, a home eNode B, anLPN, a Relay and a Small Cell.

Preferably, the second nodes are configured to: determine corresponding random access channel resources according to the random access channel configuration information and send random access signalings to the first nodes by using the random access channel resources;

the first nodes are further configured to: send random access response signalings to the second nodes to respond to the random access signalings sent by the second nodes.

The embodiments of the present invention provide a method and system for configuring random access channel resources, the first nodes send random access channel resource configuration information to the second nodes, wherein the random access channel resource configuration information contains indications of one or a plurality of pieces of random access channel configuration information, which indicates the random access channel resources for the second nodes sending the random access signalings, thereby implementing the random access channel resource configuration of the MTC UE in the LTE/LTE-A systems and solving the problem of access of the MTC UE in the LTE/LET-A systems.

### BRIEF DESCRIPTION OF DRAWINGS

FIG. 1 is a schematic diagram of random access channel resource configuration information in a method for configuring random access channel resources provided in the embodiment 1 of the present invention;

FIG. 2 is a schematic diagram of an ordering principle of PRACH starting resources in the embodiment 1 of the present invention;

FIG. 3 is a schematic diagram of PRACH resources occupied by each subset in the embodiment 2 of the present invention;

FIG. 4 is a schematic diagram of PRACH starting resources occupied by different types of second nodes in the embodiment 3 of the present invention;

FIG. 5 is a schematic diagram of random access channel resource configuration information in a method for configuring random access channel resources provided in the embodiment 5 of the present invention;

FIG. 6 is a schematic diagram of random access channel resource configuration information in a method for configuring random access channel resources provided in the embodiment 6 of the present invention;

FIG. 7 is a schematic diagram of random access channel resource configuration information in a method for configuring random access channel resources provided in the embodiment 7 of the present invention;

FIG. 8 is a schematic diagram of distribution of PRACH starting resources within 1 Frame in the embodiment 8 of the present invention;

FIG. 9 is a schematic diagram of random access channel resource configuration information in a method for configuring random access channel resources provided in the embodiment 10 of the present invention;

FIG. 10 is a schematic diagram of allocation of PRACH starting resources allocated within a plurality of Frames in the embodiment 11 of the present invention;

FIG. 11 is a schematic diagram of random access channel resource configuration information in a method for configuring random access channel resources provided in the embodiment 12 of the present invention;

FIG. 12 is a schematic diagram of PRACH resources configuration within a Frame 0 in the embodiment 12 of the present invention;

FIG. 13 is a schematic diagram of PRACH resources configuration within each Frame in the embodiment 13 of the present invention; and

FIG. 14 is a schematic diagram of PRACH resources configuration within a Frame 0 in the embodiment 13 of the present invention;

### PREFERRED EMBODIMENTS OF THE PRESENT INVENTION

The embodiments of the present invention will be described in detail in conjunction with the accompanying drawings. It should be noted that the embodiments in the present invention and the features in the embodiments can be combined with each other arbitrarily in the case of no conflict.

An embodiment of the present invention provides a method for configuring random access channel resources, first nodes send random access channel resource configuration information to second nodes, and the random access channel resource configuration information is indicated by one or a plurality of pieces of random access channel configuration information.

Configuration information of first resources is included at least in the random access channel configuration information, the first resources are one of the following:

resources used for sending random access signalings and allocated to the second nodes; and

starting resources used for sending the random access signalings and allocated to the second nodes.

In the embodiment of the present invention, descriptions will be made through an example of taking the first resources as PRACH resources or PRACH starting resources.

### Embodiment 1 of the Present Invention

The embodiment of the present invention provides a method for configuring random access channel resources, which includes:

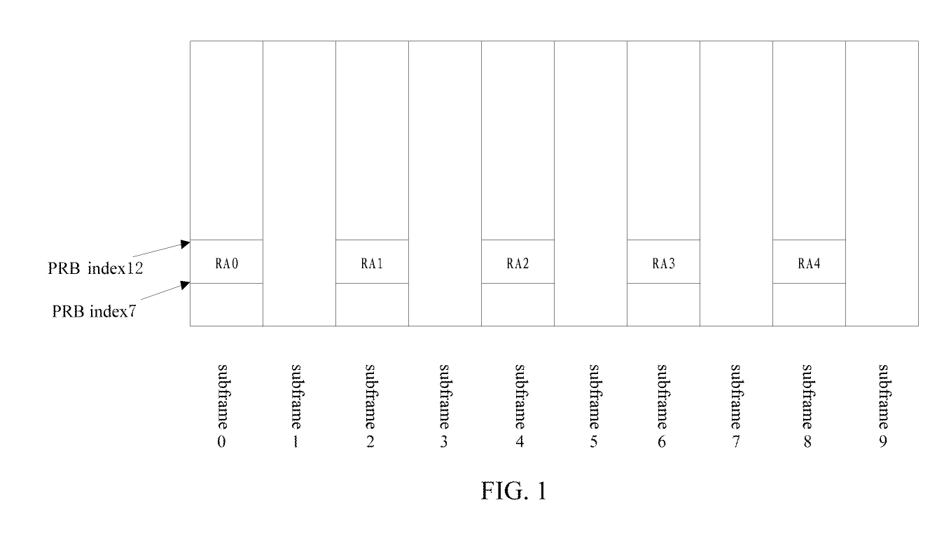

(1) The random access channel resource configuration information is indicated by one piece of random access channel configuration information, and the prach-ConfigIndex is at least contained in the random access channel configuration information.

Wherein, the prach-ConfigIndex is used to describe allocated time domain position information of the PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, it is assumed that the predefined time domain length is 1 Frame, the second nodes, by decoding the prach-ConfigIndex information sent by the first nodes, learn that the described PRACH starting resources occupy subframes 0, 2, 4, 6 and 8 in the time domain within 1 Frame, and there are starting resources of 5 PRACHs in total, as shown in FIG. 1;

further, the second nodes may be one or a plurality of terminals or one or a plurality of terminal groups;

wherein, prach-FreqOffset is used to indicate frequency domain offset information of the PRACH starting resources described by the prach-ConfigIndex in the frequency domain. In the embodiment of the present invention, the prach-FreqOffset equals to 7 and is configured by the system by default, that is, the first PRB index occupied by the described PRACH starting resources in the frequency domain within 1 Frame is a PRB Index7, as shown in FIG. 1.

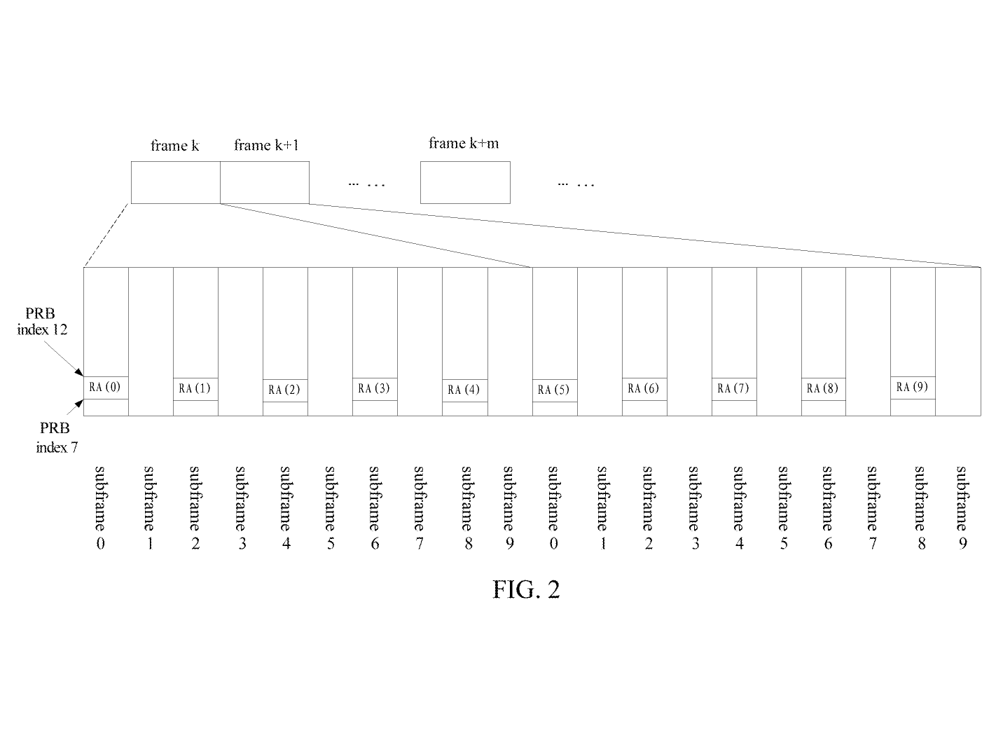

In the embodiment of the present invention, the PRACH starting resources allocated in a plurality of Frames are sequenced, as shown in FIG. 2, indexes of the PRACH starting resources in a Frame k are RA(0)˜RA(4), indexes of the PRACH starting resources in a Frame k+1 are RA(5)˜RA(9), and so on, and a PRACH starting resource set PRACHSet is formed.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The PRACHSet is divided into one or a plurality of random access channel resource subsets, each subset can support one type or more types of the second nodes sending random access sequences;

wherein, the second nodes may be sorted according to one of the following principles:

sorted according to different coverage improvement levels required to be supported by the second nodes;

allocated according to the number of repeated transmissions of the random access sequences required to be supported by the second nodes; and

repeat times of the Physical Broadcast Channel (PBCH) used when the PBCH is decoded successfully by the second nodes.

In the embodiment of the present invention, the second nodes are divided into two types (Type_1 and Type_2) according to the coverage improvement levels required to be supported and the PRACHSet is divided into two subsets (a subset 1 and a subset 2), the indexes of the PRACH starting resources occupied by each subset is configured by the system or sent by the first nodes. Each subset supports one type of the second nodes sending the random access sequences, for example, the second nodes of the Type_1 send the random access sequences on the subset 1, and the second nodes of the Type_2 send the random access sequences on the subset 2.

Wherein, the first nodes illustrated are one of the following:

a Macrocell, a Microcell, a Picocell, a Femtocell (also called a home eNode B), a low power node (LPN), a Relay and a Small Cell.

The indexes of the PRACH starting resources in the subsets may be chosen based on the following formula:

Subset_i={RAIdx|mod(RAIdx,Interval_{Subset}_{_}ᵢ)=b_{Subset}_{_}ᵢ,0≦b_{Subset}_{_}ᵢ≦Interval_{Subset}_{_}ᵢ−1},

wherein, RAIdx is an index of the PRACH starting resources in the PRACHSet, the values thereof are RA(0), RA(1), . . . ;

Interval_{Subset}_{_}ᵢ is a spacing between time domain positions of the PRACH starting resources in a subset i;

b_{Subset}_{_}ᵢ is an index offset of the PRACH starting resources in the subset i; and

Subset_i is an index of the PRACH starting resources of the subset i.

In the embodiment of the present invention, it is assumed that Interval_{Subset}_{_}₁=2, Interval_{Subset}_{_}₂=2, b_{Subset}_{_}₁=0 and b_{Subset}_{_}₂=1, then the indexes of the PRACH starting resources of the subset 1 are RA(0), RA(2), RA(4), . . . ; the indexes of the PRACH starting resources of the subset 2 are RA(1), RA(3), RA(5), . . . , wherein information of the Interval_{Subset}_{_}₁=2, Interval_{Subset}_{_}₂=2, b_{Subset}_{_}₁=0 and b_{Subset}_{_}₂=1 is configured by the system or sent by the first nodes;

(3) When the second nodes send the random access sequences, the indexes of the occupied starting resources may be obtained in the following manners:

the indexes of the PRACH starting resources of each subset are resequenced and then determined based on the following formula:

Type_i_Start′={RAIdx′|mod(RAIdx′,RACHRepTime_{Type}_{_}ᵢ′)=0},

wherein, RAIdx′ is a resequenced index of the PRACH starting resources, the values thereof are RA′(0), RA′(1), . . . ;

RACHRepTime_{Type}_{_}ᵢ′ is the number of the PRACH starting resources included in the resources occupied by the random access signalings sent by the second nodes of a type i (Type_i); and

Type_i_Start is the index of the starting resources occupied when the second nodes of the type i (Type_i) send the random access sequences.

In the embodiment of the present invention, the indexes of the PRACH starting resources of the second nodes of the type 1 (Type_1) are RA(0), RA(2), RA(4), . . . , and it is assumed that the time domain length of the random access sequences sent by the second nodes of the type 1 is 4 subframes and RACHRepTime_{Type}_{_}ᵢ′=2, then the indexes of the starting resources when the second nodes of the type 1 (Type_1) send the random access sequences are RA′(0), RA′(2), RA′(4), . . . , i.e., the indexes RA(0), RA(4), RA(8), . . . .

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the types of the second nodes of the random access response information may be carried in the same random access response signaling, and they are configured by the system or sent to the second nodes by the first nodes.

In the embodiment of the present invention, it is assumed that two second nodes, such as a User Equipment 1 (UE1) and a User Equipment 2 (UE2) are carried in the random access response signalings and the UE1 and UE2 belong to the same type, that is, the coverage improvement levels of the UE1 and UE2 are same or the repeat times of transmission of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 2 of the Present Invention

The embodiment of the present invention provides a configuration for random access channel resources, the procedure of accomplishing the MTC UE access by using the method is as follows, which includes:

(1) Random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length, as shown in Table 1, wherein, “PreambleFormat” represents a random access sequence format; “System frame number” represents a system frame number (Even represents an even frame, and Any represents any frame); and “Subframe number” represents a subframe number.

TABLE 1
prach-ConfigIndex resource mapping table

| | | System | |
|---|---|---|---|
| | Preamble | frame | Subframe |
| prach-ConfigIndex | Format | number | number |
| 0 | 0 | Even | 1 |
| 1 | 0 | Even | 4 |
| 2 | 0 | Even | 7 |
| 3 | 0 | Any | 1 |
| 4 | 0 | Any | 4 |
| 5 | 0 | Any | 7 |
| 6 | 0 | Any | 1, 6 |
| 7 | 0 | Any | 2, 7 |
| 8 | 0 | Any | 3, 8 |
| 9 | 0 | Any | 1, 4, 7 |
| 10 | 0 | Any | 2, 5, 8 |
| 11 | 0 | Any | 3, 6, 9 |
| 12 | 0 | Any | 0, 2, 4, 6, 8 |
| 13 | 0 | Any | 1, 3, 5, 7, 9 |
| 14 | 0 | Any | 0, 1, 2, 3, |
| | | | 4, 5, 6, 7, |
| | | | 8, 9 |
| 15 | 0 | Even | 9 |

In the embodiment of the present invention, if prach-ConfigIndex=12, then PreambleFormat=“0”, indicating that the random access sequence format is PreambleFormat 0; System frame number=“Any”, indicating that PRACH starting resources exist in any frame; Subframe number=“0, 2, 4, 6, 8”, indicating that the PRACH starting resources exist in the subframe 0, subframe 2, subframe 4, subframe 6 and subframe 8, since there are starting resources of only one RPACH at most in each subframe by default, there are starting resources of 5 PRACHs in one Frame in the embodiment of the present invention, as shown in FIG. 1.

Further, the second nodes may be one or a plurality of terminals or one or a plurality of terminal groups.

Wherein, the prach-FreqOffset is used to indicate frequency domain offset information of the PRACH starting resources described by the prach-ConfigIndex in the frequency domain. In the embodiment of the present invention, prach-FreqOffset=7, that is, the first PRB index occupied by the described PRACH starting resources in the frequency domain within 1 Frame is a PRB Index7, as shown in FIG. 1.

In the embodiment of the present invention, the PRACH starting resources allocated in a plurality of Frames are sequenced, as shown in FIG. 2, indexes of the PRACH starting resources in a Frame k are RA(0)˜RA(4), indexes of the PRACH starting resources in a Frame k+1 are RA(5)˜RA(9), and so on, and a PRACH starting resource set PRACHSet is formed.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The PRACHSet is divided into one or a plurality of random access channel resource subsets, each subset can support one type or more types of the second nodes sending random access sequences;

wherein, the second nodes may be sorted according to one of the following principles:

sorted according to different coverage improvement levels required to be supported by the second nodes;

allocated according to the number of repeated transmissions of the random access sequences required to be supported by the second nodes; and

repeat times of the Physical Broadcast Channel (PBCH) used when the PBCH is decoded successfully by the second nodes;

in the embodiment of the present invention, the second nodes are divided into two types (Type_1 and Type_2) according to different numbers of repeated transmissions of the random access sequences required to be supported and the PRACHSet is divided into two subsets (a subset 1 and a subset 2), the indexes of the PRACH starting resources occupied by each subset are configured by the system or sent by the first nodes. Each subset supports one type of the second nodes sending the random access sequences, for example, the second nodes of the Type_1 send the random access sequences on the subset 1, and the second nodes of the Type_2 send the random access sequences on the subset 2.

In the embodiment of the present invention, the random access sequences sent by the second node of the Type_1 occupy 2 subframes, and the random access sequences sent by the second node of the Type_2 occupy 4 subframes;

wherein, the first nodes illustrated are one of the following:
a Macrocell, a Microcell, a Picocell, a Femtocell (also called a home eNode B), a low power node (LPN), a Relay and a Small Cell.

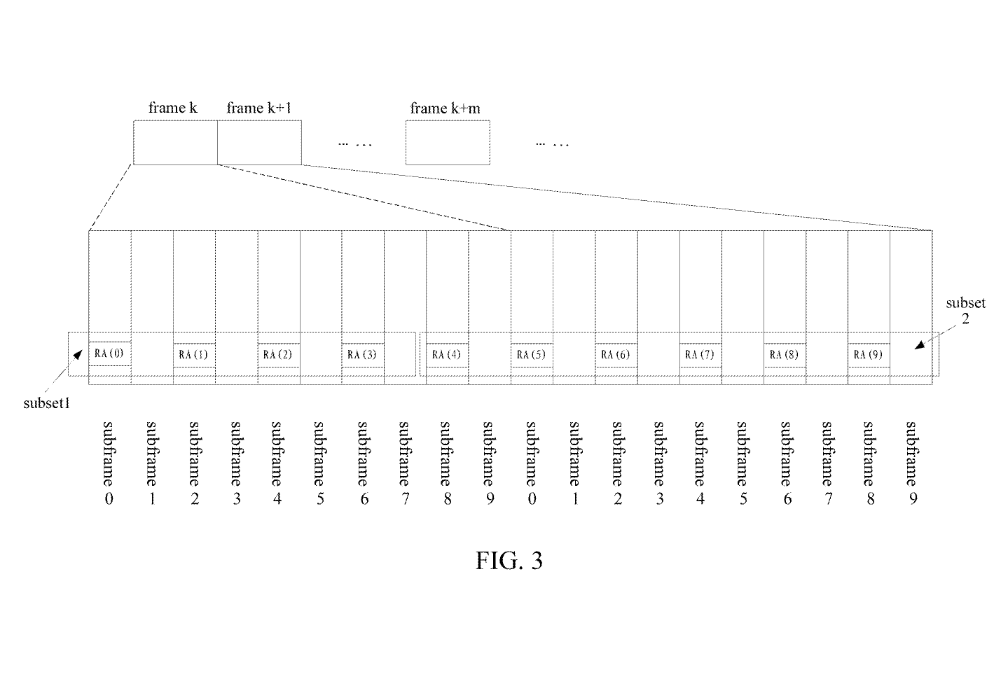

In the embodiment of the present invention, the indexes of the PRACH starting resources occupied by the subset 1 are RA(0)˜RA(3), RA(10)˜RA(13), RA(20)˜RA(23), . . . , the indexes of the PRACH starting resources occupied by the subset 2 are RA(4)˜RA(9), RA(14) RA(19), RA(24)˜RA(29), . . . , as shown in FIG. 3.

(3) When the second nodes send the random access sequences, the indexes of the occupied starting resources may be obtained in the following manners:

in the embodiment of the present invention, the indexes of the PRACH starting resources occupied when the second nodes of the Type_1 send the random access sequences on the subset 1 may be chosen from the RA(0)˜RA(3), RA(10)˜RA(13), RA(20)˜RA(23), . . . ; the indexes of the PRACH starting resources occupied when the second nodes of the Type_2 send the random access sequences on the subset 2 may be chosen from the RA(4), RA(6), RA(8), RA(14), RA(16), RA(18), RA(24), RA(26), RA(28), . . . .

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the type of the second nodes of the random access response information may be carried in the same random access response signaling, and they are configured by the system or sent to the second nodes by the first nodes.

In the embodiment of the present invention, it is assumed that two second nodes, such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

The above types of the second nodes may be varied with different environments where the UE is located, and they are not constant after being set, the concept of the type in the embodiment of the present invention is a concept similar to a set, when the corresponding division principle is met, the second nodes are assigned to the corresponding type.

### Embodiment 3 of the Present Invention

The embodiment of the present invention provides a method for configuring random access channel resources, the procedure of accomplishing the MTC UE access by using the method is as follows, which includes:

(1) Random access channel resource configuration information is indicated by one piece of random access channel configuration information, prach-FreqOffset is at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, it is assumed that the predefined time domain length is 1 Frame and the prach-ConfigIndex information is configured by the system by default, for example, the described PRACH starting resources occupy subframes 0, 2, 4, 6 and 8 in the time domain within 1 Frame, and there are starting resources of 5 PRACHs in total, as shown in FIG. 1;

further, the second nodes may be one or a plurality of terminals or one or a plurality of terminal groups.

Wherein, the prach-FreqOffset is used to indicate frequency domain offset information of the PRACH starting resources described by the prach-ConfigIndex in the frequency domain. In the embodiment of the present invention, prach-FreqOffset=7, that is, the first PRB index occupied by the described PRACH starting resources in the frequency domain within 1 Frame is a PRB Index7, as shown in FIG. 1.

In the embodiment of the present invention, the PRACH starting resources allocated in a plurality of Frames are sequenced, as shown in FIG. 2, indexes of the PRACH starting resources in a Frame k are RA(0)˜RA(4), indexes of the PRACH starting resources in a Frame k+1 are RA(5)˜RA(9), and so on.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The random access channel resources are divided into one or a plurality of random access channel resource subsets, each subset can support one type or more types of the second nodes sending random access sequences;

wherein, the second nodes may be sorted according to one of the following principles:

sorted according to different coverage enhancement levels required to be supported by the second nodes;

allocated according to the number of repeated transmissions of the random access sequences required to be supported by the second nodes; and

repeat times of the PBCH channel used accumulatively when the PBCH is decoded successfully by the second nodes.

In the embodiment of the present invention, the second nodes are divided into four types (Type_1, Type_2, Type_3 and Type_4) according to different repeat times of the PBCH channel used accumulatively when the PBCH is decoded successfully by the second nodes and the random access channel resources are divided into two subsets (a subset 1 and a subset 2), the indexes of the PRACH starting resources occupied by each subset are configured by the system or sent by the first nodes. Each subset supports two types of the second nodes sending the random access sequences, for example, the second nodes of the Type_1 and Type_2 send the random access sequences on the subset 1, and the second nodes of the Type_3 and Type_4 send the random access sequences on the subset 2.

In the embodiment of the present invention, the random access sequences sent by the second nodes of the Type_1 occupy 2 subframes, the random access sequences sent by the second nodes of the Type_2 occupy 6 subframes; the random access sequences sent by the second nodes of the Type_3 occupy 4 subframes, and the random access sequences sent by the second nodes of the Type_4 occupy 8 subframes.

Wherein, the first nodes illustrated are one of the following:

a Macrocell, a Microcell, a Picocell, a Femtocell (also called a home eNode B), a low power node (LPN), a Relay and a Small Cell.

In the embodiment of the present invention, the indexes of the PRACH starting resources occupied by the subset 1 are RA(0)˜RA(3), RA(10)˜RA(13), RA(20)˜RA(23), . . . , the indexes of the PRACH starting resources occupied by the subset 2 are RA(4)˜RA(9), RA(14) RA(19), RA(24)˜RA(29), . . . , as shown in FIG. 3.

(3) When the second nodes send the random access sequences, the indexes of the occupied starting resources may be obtained in the following manners:

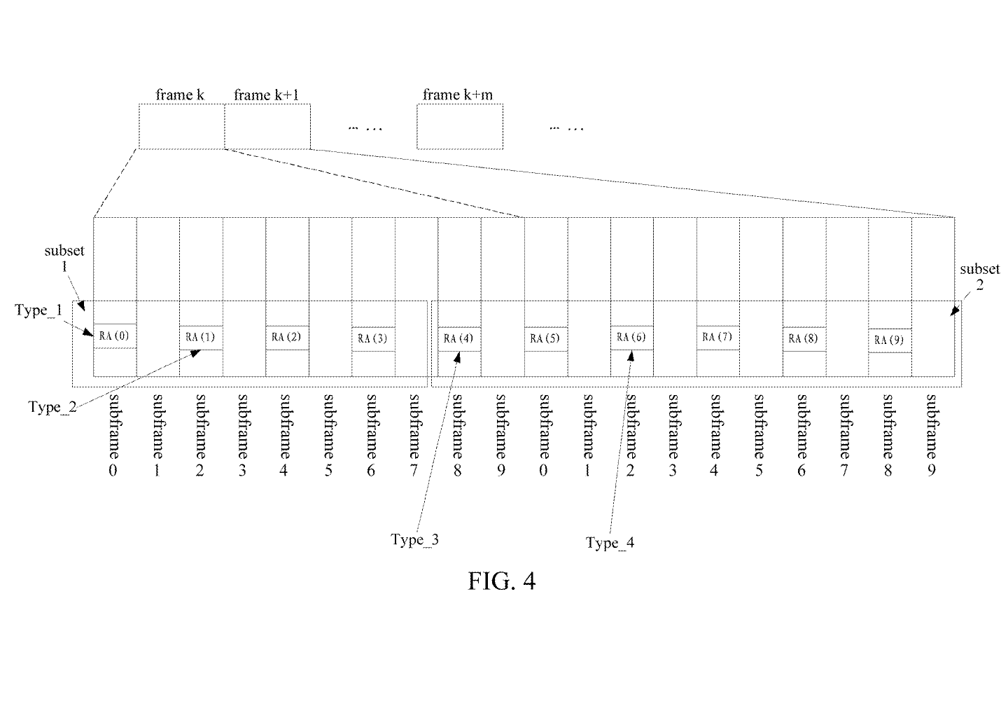

in the embodiment of the present invention, the indexes of the PRACH starting resources occupied when the second nodes of the Type_1 send the random access sequences on the subset 1 are chosen from the RA(0), RA(10), RA(20), . . . ; the indexes of the PRACH starting resources occupied when the second nodes of the Type_2 send the random access sequences on the subset 1 may be chosen from the RA(1), RA(11), RA(21), . . . ; the indexes of the PRACH starting resources occupied when the second nodes of the Type_3 send the random access sequences on the subset 2 may be chosen from the RA(4), RA(14), RA(24), . . . ; and the indexes of the PRACH starting resources occupied when the second nodes of the Type_4 send the random access sequences on the subset 2 may be chosen from the RA(6), RA(16), RA(26), . . . , as shown in FIG. 4.

(4) The second nodes send the random access signalings on the allocated random access resources;

(5) After the first nodes receive the random access signalings sent by the second nodes, the first nodes send random access response signalings to the second nodes to respond to the random access signalings sent by the second nodes;

wherein, the random access response information of one or a plurality of the second nodes is carried in the random access response signalings; and the type of the second nodes of the random access response information may be carried in the same random access response signaling, and they are configured by the system or sent to the second nodes by the first nodes.

In the embodiment of the present invention, it is assumed that two second nodes, such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 4 of the Present Invention

The embodiment of the present invention provides a configuration for random access channel resources, the procedure of accomplishing the MTC UE access by using the method is as follows, which includes:

(1) Random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, it is assumed that the predefined time domain length is 1 Frame, the second nodes, by decoding the prach-ConfigIndex information sent by the first nodes, learn that the described PRACH starting resources occupy subframes 0, 2, 4, 6 and 8 in the time domain within 1 Frame, and there are starting resources of 5 PRACHs in total, as shown in FIG. 1.

Further, the second nodes may be one or a plurality of terminals or one or a plurality of terminal groups.

Wherein, the prach-FreqOffset is used to indicate frequency domain offset information of the PRACH starting resources described by the prach-ConfigIndex in the frequency domain. In the embodiment of the present invention, prach-FreqOffset=7, that is, the first PRB index occupied by the described PRACH starting resources in the frequency domain within 1 Frame is a PRB Index7, as shown in FIG. 1.

In the embodiment of the present invention, the PRACH starting resources allocated in a plurality of Frames are sequenced, as shown in FIG. 2, indexes of the PRACH starting resources in a Frame k are the RA(0)˜RA(4), indexes of the PRACH starting resources in a Frame k+1 are the RA(5)˜RA(9), and so on.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The random access channel resources are divided into one or a plurality of random access channel resource subsets, each subset can support one type or more types of the second nodes sending the random access sequences;

wherein, the second nodes may be sorted according to one of the following principles:

sorted according to different repeat times of a Master Information Block (MIB) message when the MIB message is decoded successfully by the second nodes;

sorted according to different repeat times of a System Information Block (SIB) message when the SIB message is decoded successfully by the second nodes; and

sorted according to different repeat times of the MIB message when the PBCH is decoded successfully by the second nodes.

In the embodiment of the present invention, the second nodes are sorted according to the number of repetitions repeat times of the Master Information Block (MIB) message when the MIB message is decoded successfully, for example, they are divided into four types (Type_1, Type_2, Type_3 and Type_4), and the random access channel resources are divided into two subsets (a subset 1 and a subset 2), the indexes of the PRACH starting resources occupied by each subset are configured by the system or sent by the first nodes. Each subset supports two types of the second nodes sending the random access sequences, for example, the second nodes of the Type_1 and Type_2 send the random access sequences on the subset 1, and the second nodes of the Type_3 and Type_4 send the random access sequences on the subset 2. The indexes of the random access sequences used by the two types of the second nodes to which the same subset is allocated are different;

wherein, the first nodes illustrated are one of the following:

a Macrocell, a Microcell, a Picocell, a Femtocell (also called a home eNode B), a low power node (LPN), a Relay and a Small Cell;

the indexes of the PRACH starting resources in the subsets may be chosen based on the following formula:

Subset_i={RAIdx|mod(RAIdx,Interval_{Subset}_{_}ᵢ)=b_{Subset}_{_}ᵢ,0≦b_{Subset}_{_}ᵢ≦Interval_{Subset}_{_}ᵢ−1},

wherein, RAIdx is an index of the PRACH starting resources, the values thereof are RA(0), RA(1), . . . ;

Interval_{Subset}_{_}ᵢ is a spacing between time domain positions of the PRACH starting resources in a subset i;

b_{Subset}_{_}ᵢ is an index offset of the PRACH starting resources in the subset i; and

Subset_i is an index of the PRACH starting resources in the subset i;

in the embodiment of the present invention, it is assumed that Interval_{Subset}_{_}₁=2, Interval_{Subset}_{_}₂=2 b_{Subset}_{_}₁=0 and b_{Subset}_{_}₂=1, then the indexes of the PRACH starting resources in the subset 1 are the RA(0), RA(2), RA(4), . . . ; the indexes of the PRACH starting resources in the subset 2 are the RA(1), RA(3), RA(5), . . . ; wherein information of the Interval_{Subset}_{_}₁=2, Interval_{Subset}_{_}₂=2, b_{Subset}_{_}₁=0 and b_{Subset}_{_}₂=1 is configured by the system or sent by the first nodes;

(3) When the second nodes send the random access sequences, the indexes of the occupied starting resources may be obtained in the following manners:

the indexes of the PRACH starting resources in each subset are resequenced and then determined based on the following formula:

Type_j_Start_{subset}_{_}ᵢ={RAIdx′|mod(RAIdx′,RACHRepTime_{subset}_{_}ᵢ^{Tyep}^{_}^{j})=0},

wherein, RAIdx′ is a resequenced index of the PRACH starting resources in each subset, the values thereof are RA′(0), RA′(1), . . . ;

RACHRepTime_{subset}_{_}ᵢ^{Tyep}^{_}^{j} is the number of the PRACH starting resources included in the resources occupied by the random access signalings sent by the second nodes of a type j (Type_j); and

Type_j_Start_{Subset}_{_}ᵢ is the index of the starting resources occupied when the second nodes of the type j (Type_j) send the random access sequences.

In the embodiment of the present invention, the indexes of the PRACH starting resources of the second nodes of the Type_1 and Type_2 are the RA(0), RA(2), RA(4), . . . , and it is assumed that the time domain length of the random access sequences sent by the Type_1 is 2 subframes and RACHRepTime_{subset}_{_}₁^{Tyep}^{_}¹=1, and the time domain length of the random access sequences sent by the Type_2 is 4 subframes and RACHRepTime_{subset}_{_}₁^{Tyep}^{_}²=2, then the indexes of the starting resources when the Type_1 sends the random access sequences are RA′(0), RA′(1), RA′(2), . . . , i.e., indexes RA(0), RA(2), RA(4), . . . ; and the indexes of the starting resources when the Type_2 sends the random access sequences are RA′(0), RA′(2), RA′(4), . . . , i.e., indexes RA(0), RA(4), RA(8), . . . .

In the embodiment of the present invention, the indexes of the PRACH starting resources of the second nodes of the Type_3 and Type_4 are the RA(1), RA(3), RA(5), . . . , and it is assumed that the time domain length of the random access sequences sent by the Type_3 is 2 subframes and RACHRepTime_{subset}_{_}₂^{Tyep}^{_}³=1, and the time domain length of the random access sequences sent by the Type_4 is 4 subframes and RACHRepTime_{subset}_{_}₂^{Tyep}^{_}⁴=2, then the indexes of the starting resources when the Type_3 sends the random access sequences are RA′(0), RA′(1), RA′(2), . . . , i.e., indexes RA(1), RA(3), RA(5), . . . ; and the indexes of the starting resources when the Type_4 sends the random access sequences are RA′(0), RA′(2), RA′(4), . . . , i.e., indexes RA(1), RA(5), RA(7), . . . .

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the type of the second nodes of the random access response information may be carried in the same random access response signaling, and it is configured by the system or sent to the second nodes by the first nodes.

In the embodiment of the present invention, it is assumed that two second nodes such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 5 of the Present Invention

The embodiment of the present invention provides a configuration for random access channel resources, the procedure of accomplishing the MTC UE access by using the method is as follows, which includes:

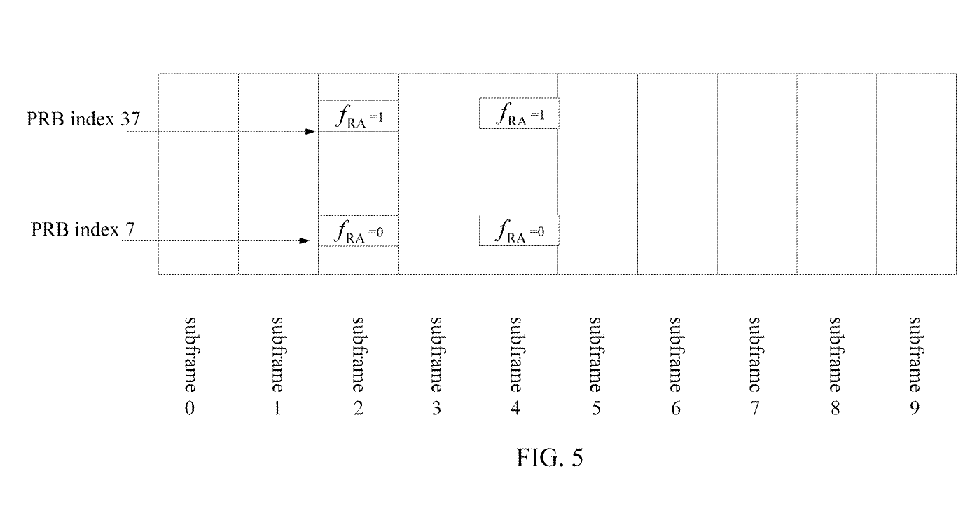

(1) Random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, it is assumed that the predefined time domain length is 1 Frame, the second nodes, by decoding the prach-ConfigIndex information sent by the first nodes, learn that the described PRACH starting resources occupy subframes 2 and 4 in the time domain within 1 Frame, and there are starting resources of 4 PRACHs in total, as shown in FIG. 5.

Wherein, the prach-FreqOffset is used to indicate the first PRB index occupied by the PRACH starting resources described by the prach-ConfigIndex in the frequency domain.

Further, the second nodes may be one or a plurality of terminals or one or a plurality of terminal groups.

In the embodiment of the present invention, the minimum PRB index n_{PRB}^{RA} of the starting resources of each PRACH in the frequency domain is obtained based on the following formula:

$${n}_{PRB}^{RA} = \{ \begin{matrix}{n}_{PRB offset}^{RA} + 6 [ \frac{{f}_{RA}}{2} ] , if {f}_{RA} mod 2 = 0 \\ {N}_{RB}^{UL} - 6 - {n}_{PRB offset}^{RA} - 6 [ \frac{{f}_{RA}}{2} ] , otherwise\end{matrix} ,$$

wherein, the value of n_{PRB offset}^{RA} is described by the prach-FreqOffset, e.g., n_{PRB offset}^{RA}=7;

N_{RB}^{UL} is the magnitude of the uplink system bandwidth with the PRB as a unit, e.g., N_{RB}^{UL}=50; and

f_{RA} is an index of the starting resources of the PRACHs in the same subframe, e.g., f_{RA}=0˜1;

a schematic diagram of the PRACH starting resources distribution within the subframe 2 and subframe 4 is as shown in FIG. 5.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The random access channel resources are divided into one or a plurality of random access channel resource subsets, each subset can support one type or more types of the second nodes sending random access sequences;

wherein, the second nodes may be sorted according to one of the following principles:

sorted according to different repeat times of a Master Information Block (MIB) message when the MIB message is decoded successfully by the second nodes;

sorted according to different repeat times of a System Information Block (SIB) message when the SIB message is decoded successfully by the second nodes; and

sorted according to different repeat times of the MIB message when the PBCH is decoded successfully by the second nodes.

In the embodiment of the present invention, the second nodes are sorted according to different repeat times of the System Information Block (SIB) message when the SIB message is decoded successfully, for example, they are divided into two types (Type_1 and Type_2) and the random access channel resources are divided into two subsets (a subset 1 and a subset 2), the indexes of the PRACH starting resources occupied by each subset are configured by the system or sent by the first nodes. Each subset supports one type of the second nodes sending the random access sequences, for example, the second nodes of the Type_1 send the random access sequences on the subset 1, and the second nodes of the Type_2 send the random access sequences on the subset 2.

Wherein, the first nodes illustrated are one of the following:

a Macrocell, a Microcell, a Picocell, a Femtocell (also called a home eNode B), a low power node (LPN), a Relay and a Small Cell.

In the embodiment of the present invention, the index of the PRACH starting resources in the subset 1 is f_{RA}=0 in each Frame; the index of the PRACH starting resources in the subset 2 is f_{RA}=1 in each Frame.

(3) When the second nodes send the random access sequences, the indexes of the occupied starting resources may be obtained in the following manners:

the indexes of the PRACH starting resources allocated to each type of the second nodes are resequenced and then determined based on the following formula:

Type_i_Start′={RAIdx′|mod(RAIdx′,RACHRepTime_{Type}_{_}ᵢ′)=0},

wherein, RAIdx′ is a resequenced index of the PRACH starting resources in each subset, the values thereof are RA′(0), RA′(1), . . . ;

RACHRepTime_{Type}_{_}ᵢ′ is the number of the PRACH starting resources included in the resources occupied by the random access signalings sent by the second nodes of the type i (Type_i); and

Type_i_Start′ is the index of the starting resources occupied when the second nodes of the type i (Type_i) send the random access sequences.

In the embodiment of the present invention, the indexes of the PRACH starting resources of the second nodes of the type 1 (Type_1) are f_{RA}=0 of the subframe 2 and f_{RA}=0 of the subframe 4 in the Frame and are resequenced as the RA′(0), RA′(1), RA′(2), . . . , and it is assumed that the time domain length of the random access sequences sent by the Type_1 is 4 subframes and RACHRepTime_{Type}_{_}₁′=2, then the indexes of the starting resources when the Type_1 sends the random access sequences are the RA′(0), RA′(2), RA′(4), . . . ; the indexes of the PRACH starting resources of the second nodes of the type 2 (Type_2) are f_{RA}=1 of the subframe 2 and subframe 4 in the Frame and are resequenced as the RA′(0), RA′(1), RA′(2), . . . , and it is assumed that the time domain length of the random access sequences sent by the Type_2 is 2 subframes and RACHRepTime_{Type}_{_}₂′=1, then the indexes of the starting resources when the Type_2 sends the random access sequences are the RA′(0), RA′(1), RA′(2), . . . .

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the type of the second nodes of the random access response information may be carried in the same random access response signaling, and it is configured by the system or sent to the second nodes by the first nodes.

In the embodiment of the present invention, it is assumed that two second nodes such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 6 of the Present Invention

The embodiment of the present invention provides a configuration for random access channel resources, the procedure of accomplishing the MTC UE access by using the method is as follows, which includes:

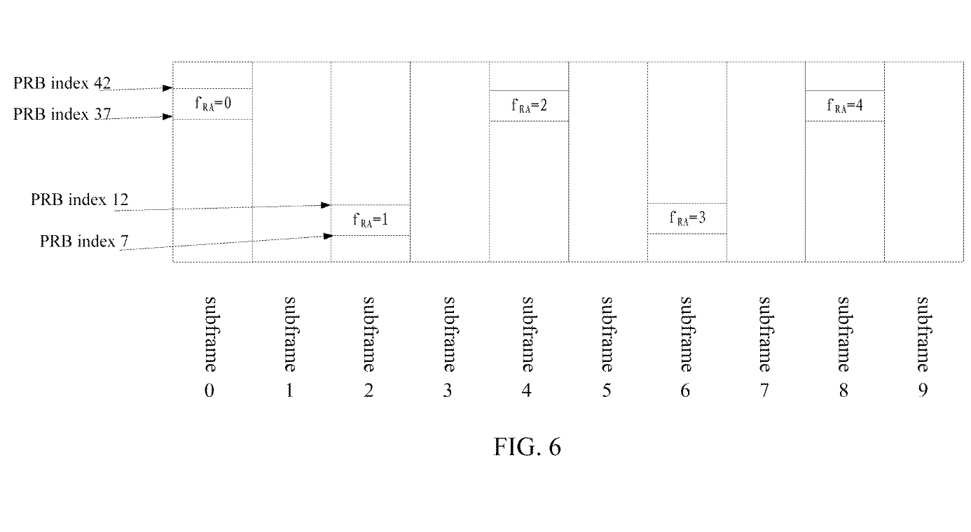

(1) Random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, it is assumed that the predefined time domain length is 1 Frame, the second nodes, by decoding the prach-ConfigIndex information sent by the first nodes, learn that the described PRACH starting resources occupy subframes 0, 2, 4, 6, and 8 in the time domain within 1 Frame, as shown in FIG. 6;

wherein, the prach-FreqOffset is used to indicate the first PRB index occupied by the PRACH starting resources described by the prach-ConfigIndex in the frequency domain;

further, the second nodes may be one or a plurality of terminals or one or a plurality of terminal groups;

in the embodiment of the present invention, the minimum PRB index n_{PRB}^{RA} of the starting resources of each PRACH in the frequency domain is obtained based on the following formula:

$${n}_{PRB}^{RA} = \{ \begin{matrix}{n}_{PRB offset}^{RA} + 6 [ \frac{{f}_{RA}}{2} ] , if {f}_{RA} mod 2 = 0 \\ {N}_{RB}^{UL} - 6 - {n}_{PRB offset}^{RA} - 6 [ \frac{{f}_{RA}}{2} ] , otherwise\end{matrix} ,$$

wherein, the value of n_{PRB offset}^{RA} is described by the prach-FreqOffset, e.g., n_{PRB offset}^{RA}=7;

N_{RB}^{UL} is the magnitude of the uplink system bandwidth with the PRB as a unit, e.g., N_{RB}^{UL}=50; and

f_{RA} is an index of the starting resources of different PRACHs in 1 Frame, e.g., f_{RA}=0˜4;

a schematic diagram of the PRACH starting resources distribution within 1 Frame is as shown in FIG. 6.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The random access channel resources are divided into one or a plurality of random access channel resource subsets, each subset can support one type or more types of the second nodes sending random access sequences;

wherein, the second nodes may be sorted according to one of the following principles:

sorted according to different repeat times of a Master Information Block (MIB) message when the MIB message is decoded successfully by the second nodes;

sorted according to different repeat times of a System Information Block (SIB) message when the SIB message is decoded successfully by the second nodes; and

sorted according to different repeat times of the MIB message when the PBCH is decoded successfully by the second nodes.

In the embodiment of the present invention, the second nodes are sorted according to different repeat times of the MIB message when the PBCH is decoded successfully, for example, they are divided into two types (Type_1 and Type_2), and the random access channel resources are divided into two subsets (a subset 1 and a subset 2), the indexes occupied by each subset are configured by the system or sent by the first nodes. Each subset supports one type of the second nodes sending the random access sequences, for example, the second nodes of the Type_1 send the random access sequences on the subset 1, and the second nodes of the Type_2 send the random access sequences on the subset 2.

Wherein, the first nodes illustrated are one of the following:

a Macrocell, a Microcell, a Picocell, a Femtocell (also called a home eNode B), a low power node (LPN), a Relay and a Small Cell.

In the embodiment of the present invention, the indexes of the PRACH starting resources in the subset 1 are f_{RA}=0, 1, 2 in each Frame; the indexes of the PRACH starting resources in the subset 2 are f_{RA}=3, 4 in each Frame.

(3) When the second nodes send the random access sequences, the indexes of the occupied starting resources may be obtained in the following manners:

the PRACH starting resources allocated to each type of the second nodes are resequenced and then determined based on the following formula:

Type_i_Start′={RAIdx′|mod(RAIdx′,RACHRepTime_{Type}_{_}ᵢ′)=0},

wherein, RAIdx′ is a resequenced index of the PRACH starting resources allocated to the second nodes of the Type_i, the values thereof are RA′(0), RA′(1), RA′(2), . . . ;

RACHRepTime_{Type}_{_}ᵢ′ is the number of the PRACH starting resources included in the resources occupied by the random access signalings sent by the second nodes of the type i (Type_i); and

Type_i_Start′ is the index of the starting resources occupied when the second nodes of the type i (Type_i) send the random access sequences.

In the embodiment of the present invention, the indexes of the PRACH starting resources of the second nodes of the type 1 (Type_1) are RA′(0), RA′(1), RA′(2), . . . , and it is assumed that the time domain length of the random access sequences sent by the second nodes of the Type_1 is 6 subframes and RACHRepTime_{Type}_{_}ᵢ′=3, then the indexes of the starting resources when the second nodes of the type 1 (Type_1) send the random access sequences are RA′(0), RA′(3), RA′(6), . . . ; the indexes of the PRACH starting resources of the second nodes of the type 2 (Type_2) are RA′(0), RA′(1), RA′(2), . . . , and it is assumed that the time domain length of the random access sequences sent by the second nodes of the Type_2 is 4 subframes and RACHRepTime_{Type}_{_}ᵢ′=2, then the indexes of the starting resources when the second nodes of the type 1 (Type_1) send the random access sequences are RA′(0), RA′(2), RA′(4), . . . .

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the type of the second nodes of the random access response information may be carried in the same random access response signaling, and it is configured by the system or sent to the second nodes by the first nodes.

In the embodiment of the present invention, it is assumed that two second nodes such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 7 of the Present Invention

The embodiment of the present invention provides a configuration for random access channel resources, the procedure of accomplishing the MTC UE access by using the method is as follows, which includes:

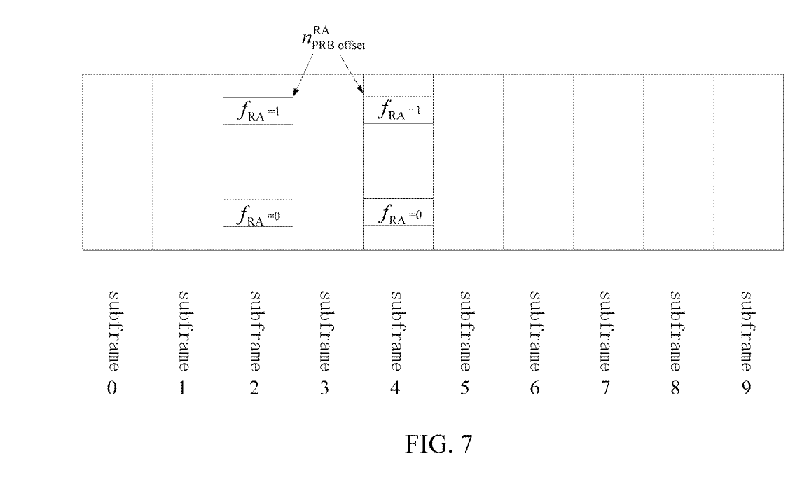

(1) Random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, it is assumed that the predefined time domain length is 1 Frame, the second nodes, by decoding the prach-ConfigIndex information sent by the first nodes, learn that the described PRACH starting resources occupy subframes 2 and 4 in the time domain within 1 Frame, and each subframe has two starting positions of the PRACH starting resources, as shown in FIG. 7.

Wherein, the prach-FreqOffset is used to indicate the first PRB index occupied by the PRACH starting resources described by the prach-ConfigIndex in the frequency domain.

Further, the second nodes may be one or a plurality of terminals or one or a plurality of terminal groups.

In the embodiment of the present invention, the minimum PRB index n_{PRB}^{RA} of the starting resources of each PRACH in the frequency domain is obtained based on the following formula:

$${n}_{PRB}^{RA} = \{ \begin{matrix}{n}_{PRB offset}^{RA} + 6 [ \frac{{f}_{RA}}{2} ] , if {f}_{RA} mod 2 = 0 \\ {N}_{RB}^{UL} - 6 - {n}_{PRB offset}^{RA} - 6 [ \frac{{f}_{RA}}{2} ] , otherwise\end{matrix} ,$$

wherein, the value of n_{PRB offset}^{RA} is described by the prach-FreqOffset, e.g., n_{PRB offset}^{RA}=7;

N_{RB}^{UL} is the magnitude of the uplink system bandwidth with the PRB as a unit, e.g., N_{RB}^{UL}=50; and

f_{RA} is an index of the starting resources of different PRACHs in the same time domain position in the frequency domain, e.g., f_{RA}=0˜1;

a schematic diagram of the PRACH starting resources distribution within 1 Frame is as shown in FIG. 7.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The random access channel resources are divided into one or a plurality of random access channel resource subsets, each subset can support one type or more types of the second nodes sending random access sequences;

wherein, the second nodes may be sorted according to one of the following principles:

sorted according to different coverage improvement levels required to be supported by the second nodes;

allocated according to different numbers of the repeated transmissions of the random access sequences required to be supported by the second nodes; and

the repeat times of the Physical Broadcast Channel (PBCH) used when the PBCH is decoded successfully by the second nodes.

In the embodiment of the present invention, the second nodes are divided into two types (Type_1 and Type_2) according to the different coverage improvement levels required to be supported, and the random access channel resources are divided into two subsets (a subset 1 and a subset 2), and each subset supports one type of the second nodes sending the random access sequences, for example, the second nodes of the Type_1 send the random access sequences on the subset 1, and the second nodes of the Type_2 send the random access sequences on the subset 2.

Wherein, the first nodes illustrated are one of the following:

a Macrocell, a Microcell, a Picocell, a Femtocell (also called a home eNode B), a low power node (LPN), a Relay and a Small Cell.

In the embodiment of the present invention, the indexes of the PRACH starting resources in the subset 1 are f_{RA}=0 of the Subframe 2 and f_{RA}=1 of the Subframe 4 in each Frame; the indexes of the PRACH starting resources in the subset 2 are f_{RA}=1 of the Subframe 2 and f_{RA}=0 of the Subframe 4 in each Frame.

(3) When the second nodes send the random access sequences, the indexes of the occupied starting resources may be obtained in the following manners:

the PRACH starting resources allocated to each type of the second nodes are resequenced and then determined based on the following formula:

Type_i_Start′={RAIdx′|mod(RAIdx′,RACHRepTime_{Type}_{_}ᵢ′)=0},

wherein, RAIdx′ is a resequenced index of the PRACH starting resources, the values thereof are RA′(0), RA′(1), RA′(2), . . . ;

RACHRepTime_{Type}_{_}ᵢ′ is the number of the PRACH starting resources included in the resources occupied by the random access signalings sent by the second nodes of the type i (Type_i); and

Type_i_Start′ is the index of the starting resources occupied when the second nodes of the type i (Type_i) send the random access sequences.

In the embodiment of the present invention, the indexes of the PRACH starting resources of the second nodes of the type 1 (Type_1) are RA′(0), RA′(1), RA′(2), . . . , and it is assumed that the time domain length of the random access sequences sent by the second nodes of the Type_1 is 4 subframes and RACHRepTime_{Type}_{_}ᵢ′=2, then the indexes of the starting resources when the second nodes of the type 1 (Type_1) send the random access sequences are RA′(0), RA′(2), RA′(4), . . . ; the indexes of the PRACH starting resources of the second nodes of the type 2 (Type_2) are RA′(0), RA′(1), RA′(2), . . . , and it is assumed that the time domain length of the random access sequences sent by the second nodes of the Type_2 is 2 subframes and RACHRepTime_{Type}_{_}ᵢ′=1, then the indexes of the starting resources when the second nodes of the type 2 (Type_2) send the random access sequences are RA′(0), RA′(1), RA′(2),

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the type of the second nodes of the random access response information may be carried in the same random access response signaling, and it is configured by the system or sent to the second nodes by the first nodes.

In the embodiment of the present invention, it is assumed that two second nodes such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

In addition to the embodiment of the present invention, in the step (1), the minimum PRB index n_{PRB}^{RA} of the starting resources of each PRACH in the frequency domain may also be calculated and obtained based on the following formula:

n_{PRB}^{RA}=n_{PRB offset}^{RA}+(6+n_{PRB offset}^{RA})f_{RA},

wherein, the value of n_{PRB offset}^{RA} is described by the prach-FreqOffset, e.g., n_{PRB offset}^{RA}=7;

N_{RB}^{UL} is the magnitude of the uplink system bandwidth with the PRB as a unit, e.g., N_{RB}^{UL}=50;

f_{RA} is an index of the starting resources of different PRACHs in the same time domain position in the frequency domain; f_{RA}=0˜1; and

Δn_{PRB offset}^{RA} is a spacing between the starting resources of different PRACHs in frequency positions and it is notified by random access channel configuration signalings.

### Embodiment 8 of the Present Invention

The embodiment of the present invention provides a configuration for random access channel resources, the procedure of accomplishing the MTC UE access by using the method is as follows, which includes:

(1) Random access channel resource configuration information is indicated by a plurality of pieces of random access channel configuration information, prach-ConfigIndex and prach-FreqOffset are at least contained in the random access channel configuration information.

In the embodiment of the present invention, it is assumed that the random access channel resource configuration information is indicated by two pieces of random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system.

Wherein, the prach-FreqOffset is used to indicate frequency domain offset information of the PRACH starting resources described by the prach-ConfigIndex in the frequency domain.

In the embodiment of the present invention, it is assumed that the predefined time domain length is 1 Frame;

prach-ConfigIndex1 information in the indication of the first piece of PRACH configuration information indicates that the PRACH starting resources occupy the subframe 2 and the subframed 4 in the time domain within 1 Frame, and prach-FreqOffset1 describes that the first PRB index occupied by the PRACH starting resources in the frequency domain within 1 Frame is a PRB Index7;

prach-ConfigIndex2 information in the indication of the second piece of PRACH configuration information indicates that the PRACH starting resources occupy the subframe 2 and the subframe 4 in the time domain within 1 Frame, and prach-FreqOffset2 describes that the first PRB index occupied by the PRACH starting resources in the frequency domain within 1 Frame is a PRB Index37.

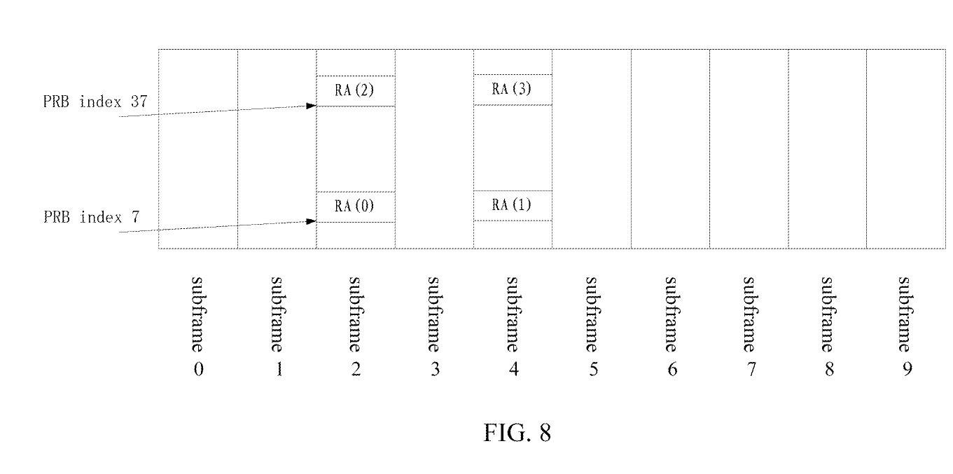

A schematic diagram of the PRACH starting resources distribution within 1 Frame is as shown in FIG. 8, the PRACH starting resources RA(0) and RA(1) are indicated by the prach-ConfigIndex1 and prach-FreqOffset1; the PRACH starting resources RA(2) and RA(3) are indicated by the prach-ConfigIndex2 and prach-FreqOffset2;

wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The random access channel resources are divided into one or a plurality of random access channel resource subsets, each subset can support one type or more types of the second nodes sending random access sequences;

wherein, the second nodes may be sorted according to one of the following principles:

sorted according to different coverage improvement levels required to be supported by the second nodes;

allocated according to the different numbers of the repeated transmissions of the random access sequences required to be supported by the second nodes; and

the repeat times of the Physical Broadcast Channel (PBCH) used when the PBCH is decoded successfully by the second nodes.

In the embodiment of the present invention, the second nodes are divided into two types (Type_1 and Type_2) according to the different coverage improvement levels required to be supported by the second nodes and the random access channel resources are divided into two subsets (a subset 1 and a subset 2), each subset supports one type of the second nodes sending the random access sequences, for example, the second nodes of the Type_1 send the random access sequences on the subset 1, and the second nodes of the Type_2 send the random access sequences on the subset 2.

Wherein, the first nodes illustrated are one of the following:

a Macrocell, a Microcell, a Picocell, a Femtocell (also called a home eNode B), a low power node (LPN), a Relay and a Small Cell.

In the embodiment of the present invention, the indexes of the PRACH starting resources in the subset 1 are RA(0) and RA(1) in each Frame; the indexes of the PRACH starting resources in the subset 2 are RA(2) and RA(3) in each Frame.

In addition to the embodiment of the present invention, the PRACH starting resources in the subset 1 may also be indicated by the prach-ConfigIndex1 and prach-FreqOffset1; the PRACH starting resources in the subset 2 may also be indicated by the prach-ConfigIndex2 and prach-FreqOffset2.

(3) When the second nodes send the random access sequences, the indexes of the occupied starting resources may be obtained in the following manners:

the indexes of the PRACH starting resources allocated to each type of the second nodes are resequenced and then determined based on the following formula:

Type_i_Start′={RAIdx′|mod(RAIdx′,RACHRepTime_{Type}_{_}ᵢ′)=0},

wherein, RAIdx′ is a resequenced index of the PRACH starting resources allocated to each type of the second nodes, the values thereof are RA′(0), RA′(1), . . . ;

RACHRepTime_{Type}_{_}ᵢ′ is the number of the PRACH starting resources included in the resources occupied by the random access signalings sent by the second nodes of the type i (Type_i); and

Type_i_Start′ is the index of the starting resources occupied when the second nodes of the type i (Type_i) send the random access sequences.

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the type of the second nodes of the random access response information may be carried in the same random access response signaling, and it is configured by the system or sent to the second nodes by the first nodes.

In the embodiment of the present invention, it is assumed that two second nodes such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 9 of the Present Invention

The embodiment of the present invention provides a configuration for random access channel resources, the procedure of accomplishing the MTC UE access by using the method is as follows, which includes:

(1) Random access channel resource confirmation information is indicated by a plurality of pieces of random access channel configuration information, prach-ConfigIndex and prach-FreqOffset are at least contained in the random access channel configuration information.

In the embodiment of the present invention, it is assumed that the random access channel resource configuration information is indicated by two pieces of random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system.

In the embodiment of the present invention, it is assumed that the predefined time domain length is 1 Frame.

prach-ConfigIndex1 information in the indication of the first piece of PRACH configuration information indicates that the PRACH starting resources occupy the subframe 2 and the subframed 4 in the time domain within 1 Frame, and prach-FreqOffset1 describes that the first PRB index occupied by the PRACH starting resources in the frequency domain within 1 Frame is a PRB Index7;

prach-ConfigIndex2 information in the indication of the second piece of PRACH configuration information indicates that the PRACH starting resources occupy the subframe 2 and the subframe 4 in the time domain within 1 Frame, and prach-FreqOffset2 describes that the first PRB index occupied by the PRACH starting resources in the frequency domain within 1 Frame is a PRB Index37.

A schematic diagram of the PRACH starting resources distribution within 1 Frame is as shown in FIG. 8, the PRACH starting resources RA(0) and RA(1) are indicated by the prach-ConfigIndex1 and prach-FreqOffset1; the PRACH starting resources RA(2) and RA(3) are indicated by the prach-ConfigIndex2 and prach-FreqOffset2.

Wherein, the random access channel configuration information may be configured in at least one of the following:

a System Information Block (SIB);

a Master Information Block (MIB); and

Downlink Control Information (DCI).

(2) The random access channel resources are divided into one or a plurality of random access channel resource subsets, each subset can support one type or more types of the second nodes sending random access sequences;

wherein, the second nodes may be sorted according to one of the following principles:

sorted according to different coverage improvement levels required to be supported by the second nodes;

allocated according to different numbers of the repeated transmissions of the random access sequences required to be supported by the second nodes; and

the repeat times of the Physical Broadcast Channel (PBCH) used when the PBCH is decoded successfully by the second nodes.

In the embodiment of the present invention, the second nodes are divided into two types (Type_1 and Type_2) according to the different coverage improvement levels required to be supported by the second nodes and the random access channel resources are divided into two subsets (a subset 1 and a subset 2), the indexes of the PRACH starting resources occupied by each subset are configured by the system or sent by the first nodes. Each subset supports one type of the second nodes sending the random access sequences, for example, the second nodes of the Type_1 send the random access sequences on the subset 1, and the second nodes of the Type_2 send the random access sequences on the subset 2.

Wherein, the first nodes illustrated are one of the following:

a Macrocell, a Microcell, a Picocell, a Femtocell (also called a home eNode B), a low power node (LPN), a Relay and a Small Cell.

In the embodiment of the present invention, the indexes of the PRACH starting resources in the subset 1 are RA(0) and RA(3) in each Frame; the indexes of the PRACH starting resources in the subset 2 are RA(2) and RA(1) in each Frame.

(3) When the second nodes send the random access sequences, the indexes of the occupied starting resources may be obtained in the following manners:

the indexes of the PRACH starting resources allocated to each type of the second nodes are resequenced and then determined based on the following formula:

Type_i_Start′={RAIdx′|mod(RAIdx′,RACHRepTime_{Type}_{_}ᵢ′)=0},

wherein, RAIdx′ is a resequenced index of the PRACH starting resources allocated to each type of the second nodes, the values thereof are RA′(0), RA′(1), . . . ;

RACHRepTime_{Type}_{_}ᵢ′ is the number of the PRACH starting resources included in the resources occupied by the random access signalings sent by the second nodes of the type i (Type_i); and

Type_i_Start′ is the index of the starting resources occupied when the second nodes of the type i (Type_i) send the random access sequences.

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the type of the second nodes of the random access response information may be carried in the same random access response signaling, and it is configured by the system or sent to the second nodes by the first nodes.

In the embodiment of the present invention, it is assumed that two second nodes such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 10 of the Present Invention

The embodiment of the present invention provides a configuration for random access channel resources, the procedure of accomplishing the MTC UE access by using the method is as follows, which includes:

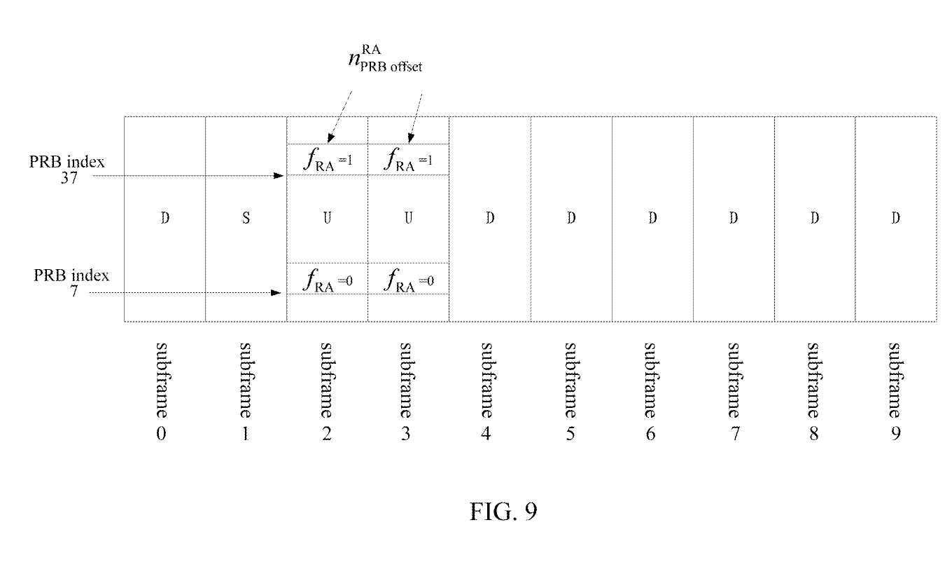

(1) There are 7 uplink and downlink subframe configuration types in TDD-LTE systems in total. The uplink and downlink subframe configuration type selected by the TDD-LTE systems in the embodiment of the present invention is 4, i.e., the frame structure of the system is as shown in FIG. 9, a subframe 0 and subframe 4˜subframe 9 are downlink subframes, a subframe 1 is a special subframe, and a subframe 2 and a subframe 3 are uplink subframes.

Random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, the subframe 2 and the subframe 3 are uplink subframes, it is assumed that the predefined time domain length is 1 Frame, the second nodes, by decoding the prach-ConfigIndex information sent by the first nodes, learn that the described PRACH starting resources occupy the subframes 2 and 3 in the time domain within 1 Frame, and there are starting resources of 4 PRACHs in total, as shown in FIG. 9.

Wherein, the prach-FreqOffset is used to indicate the first PRB index occupied by the PRACH starting resources described by the prach-ConfigIndex in the frequency domain.

Further, the second nodes may be one or a plurality of terminals or one or a plurality of terminal groups.

In the embodiment of the present invention, the minimum PRB index n_{PRB}^{RA} of the starting resources of each PRACH in the frequency domain is obtained based on the following formula:

$${n}_{PRB}^{RA} = \{ \begin{matrix}{n}_{PRB offset}^{RA} + 6 [ \frac{{f}_{RA}}{2} ] , if {f}_{RA} mod 2 = 0 \\ {N}_{RB}^{UL} - 6 - {n}_{PRB offset}^{RA} - 6 [ \frac{{f}_{RA}}{2} ] , otherwise\end{matrix} ,$$

wherein, the value of n_{PRB offset}^{RA} is described by the prach-FreqOffset, e.g., n_{PRB offset}^{RA}=7;

N_{RB}^{UL} is the magnitude of the uplink system bandwidth with the PRB as a unit, e.g., N_{RB}^{UL}=50; and

f_{RA} is an index of the starting resources of the PRACHs in the same subframe, e.g., f_{RA}=0˜1.

A schematic diagram of the PRACH starting resources distribution within the subframe 2 and the subframe 3 is as shown in FIG. 9.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The random access channel resources are divided into one or a plurality of random access channel resource subsets, each subset can support one type or more types of the second nodes sending random access sequences;

wherein, the second nodes may be sorted according to one of the following principles:

sorted according to different coverage improvement levels required to be supported by the second nodes;

allocated according to different numbers of the repeated transmissions of the random access sequences required to be supported by the second nodes; and

the repeat times of the Physical Broadcast Channel (PBCH) used when the PBCH is decoded successfully by the second nodes.

In the embodiment of the present invention, the second nodes are divided into two types (Type_1 and Type_2) according to the different coverage improvement levels required to be supported and the random access channel resources are divided into two subsets (a subset 1 and a subset 2), the indexes of the PRACH starting resources occupied by each subset are configured by the system or sent by the first nodes. Each subset supports one type of the second nodes sending the random access sequences, for example, the second nodes of the Type_1 send the random access sequences on the subset 1, and the second nodes of the Type_2 send the random access sequences on the subset 2.

Wherein, the first nodes illustrated are one of the following:

a Macrocell, a Microcell, a Picocell, a Femtocell (also called a home eNode B), a low power node (LPN), a Relay and a Small Cell.

In the embodiment of the present invention, the index of the PRACH starting resources in the subset 1 is f_{RA}=0 in each Frame; the index of the PRACH starting resources in the subset 2 is f_{RA}=1 in each Frame.

(3) When the second nodes send the random access sequences, the indexes of the occupied starting resources may be obtained in the following manners:

the indexes of the PRACH starting resources allocated to each type of the second nodes are resequenced and then determined based on the following formula:

Type_i_Start′={RAIdx′|mod(RAIdx′,RACHRepTime_{Type}_{_}ᵢ′)=0},

wherein, RAIdx′ is a resequenced index of the PRACH starting resources in each subset, the values thereof are RA′(0), RA′(1), . . . ;

RACHRepTime_{Type}_{_}ᵢ′ is the number of the PRACH starting resources included in the resources occupied by the random access signalings sent by the second nodes of the type i (Type_i); and

Type_i_Start′ is the index of the starting resources occupied when the second nodes of the type i (Type_i) send the random access sequences.

In the embodiment of the present invention, the indexes of the PRACH starting resources of the second nodes of the type 1 (Type_1) are f_{RA}=0 of the Subframe 2 and f_{RA}=0 of the Subframe 4 in the Frame and are resequenced as RA′(0), RA′(1), RA′(2), . . . , and it is assumed that the time domain length of the random access sequences sent by the Type_1 is 4 subframes and RACHRepTime_{Type}_{_}₁=2, then the indexes of the starting resources when the Type_1 sends the random access sequences are RA′(0), RA′(2), RA′(4), . . . ; the indexes of the PRACH starting resources of the second nodes of the type 2 (Type_2) are f_{RA}=1 of the subframe 2 and f_{RA}=1 of the subframe 4 in the Frame and are resequenced as RA′(0), RA′(1), RA′(2), . . . , and it is assumed that the time domain length of the random access sequences sent by the Type_2 is 2 subframes and RACHRepTime_{Type}_{_}₂ ′=1, then the indexes of the starting resources when the Type_2 sends the random access sequences are RA′(0), RA′(1), RA′(2), . . . .

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

The random access response information of one or a plurality of the second nodes is carried in the random access response signalings; and the type of the second nodes of the random access response information may be carried in the same random access response signaling, and it is configured by the system or sent to the second nodes by the first nodes.

In the embodiment of the present invention, it is assumed that two second nodes such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 11 of the Present Invention

The embodiment of the present invention provides a configuration for random access channel resources, the procedure of accomplishing the MTC UE access by using the method is as follows, which includes:

(1) Random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, it is assumed that the predefined time domain length is 1 Frame, the second nodes, by decoding the prach-ConfigIndex information sent by the first nodes, learn that the described PRACH starting resources occupy subframes 0, 2, 4, 6, and 8 in the time domain within 1 Frame, and there are starting resources of 5 PRACHs in total, as shown in FIG. 1.

Further, the second nodes may be one or a plurality of terminals or one or a plurality of terminal groups.

Wherein, prach-FreqOffset is used to indicate frequency domain offset information of the PRACH starting resources described by the prach-ConfigIndex in the frequency domain. In the embodiment of the present invention, prach-FreqOffset=7, i.e., the first PRB index n_{PRB}^{RA} occupied by the described PRACH starting resources in the frequency domain within a Frame k is determined based on the following formula:

$${n}_{PRB}^{RA} = \{ \begin{matrix}{n}_{PRB offset}^{RA} , if k mod 2 = 0 \\ {N}_{RB}^{UL} - 6 - {n}_{PRB offset}^{RA} , otherwise\end{matrix} ,$$

wherein, the value of n_{PRB offset}^{RA} is described by the prach-FreqOffset, e.g., n_{PRB offset}^{RA}=7;

N_{RB}^{UL} is the magnitude of the uplink system bandwidth with the PRB as a unit, e.g., N_{RB}^{UL}=50; and

k is a Frame index number.

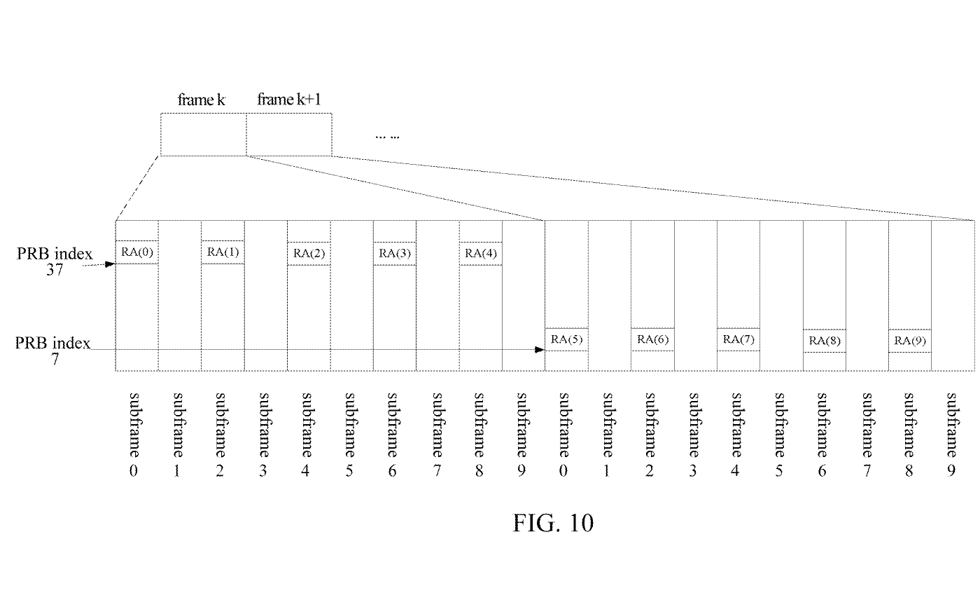

In the embodiment of the present invention, a schematic diagram of allocation of the PRACH starting resources allocated in a plurality of Frames is as shown in FIG. 10, and the PRACH starting resources allocated in the plurality of Frames are resequenced, indexes of the PRACH starting resources in the Frame k are RA(0)˜RA(4), indexes of the PRACH starting resources in a Frame k+1 are RA(5)˜RA(9), and so on.

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The random access channel resources are divided into one or a plurality of random access channel resource subsets, each subset can support one type or more types of the second nodes sending random access sequences;

wherein, the second nodes may be sorted according to one of the following principles: sorted according to different coverage improvement levels required to be supported by the second nodes;

allocated according to different numbers of the repeated transmissions of the random access sequences required to be supported by the second nodes; and

the repeat times of the Physical Broadcast Channel (PBCH) used when the PBCH is decoded successfully by the second nodes.

In the embodiment of the present invention, the second nodes are divided into two types (Type_1 and Type_2) according to the different coverage improvement levels required to be supported by the second nodes and the random access channel resources are divided into two subsets (a subset 1 and a subset 2), the indexes of the PRACH starting resources occupied by each subset are configured by the system or sent by the first nodes. Each subset supports one type of the second nodes sending the random access sequences, for example, the second nodes of the Type_1 send the random access sequences on the subset 1, and the second nodes of the Type_2 send the random access sequences on the subset 2.

In the embodiment of the present invention, the random access sequences sent by the second nodes of the Type_1 occupy 8 subframes, and the random access sequences sent by the second nodes of the Type_2 occupy 12 subframes;

wherein, the first nodes illustrated are one of the following:

a Macrocell, a Microcell, a Picocell, a Femtocell (also called a home eNode B), a low power node (LPN), a Relay and a Small Cell.

In the embodiment of the present invention, the indexes of the PRACH starting resources occupied by the subset 1 are RA(0)˜RA(1), RA(5)˜RA(6), RA(10)˜RA(11), RA(15) RA(16), . . . ; the indexes of the PRACH starting resources occupied by the subset 2 are RA(2) RA(4), RA(7)˜RA(9), RA(12)˜RA(14), RA(17)˜RA(19), . . . , as shown in FIG. 10.

(3) When the second nodes send the random access sequences, the indexes of the occupied starting resources may be obtained in the following manners:

in the embodiment of the present invention, the indexes of the PRACH starting resources occupied when the second nodes of the Type_1 send the random access sequences on the subset 1 are chosen from the RA(0), RA(10), RA(20), . . . ; the indexes of the PRACH starting resources occupied when the second nodes of the Type_2 send the random access sequences on the subset 2 may be chosen from the RA(1), RA(11), RA(21), . . . .

(4) The second nodes send the random access signalings on the allocated random access resources;

(5) After the first nodes receive the random access signalings sent by the second nodes, the first nodes send random access response signalings to the second nodes to respond to the random access signalings sent by the second nodes.

Wherein, the random access response information of one or a plurality of the second nodes is carried in the random access response signalings; and the type of the second nodes of the random access response information may be carried in the same random access response signaling, and it is configured by the system or sent to the second nodes by the first nodes.

In the embodiment of the present invention, it is assumed that two second nodes such as a User Equipment 1 (UE1) and a User Equipment 2 (UE2) are carried in the random access response signalings and the UE1 and UE2 belong to the same type, that is, the coverage improvement levels of the UE1 and UE2 are same or the number of repeated transmissions of the random access sequences required to be supported by the UE1 and UE2 are same or the RA-RNTIs calculated and obtained by the UE1 and UE2 are same.

In addition to the embodiment of the present invention, the UE1 and UE2 may also belong to different types, but it is required that the system predefine types of the second nodes which can send the random access response information in the same random access response signaling, and the UE1 and UE2 belong to the types.

### Embodiment 12 of the Present Invention

The embodiment of the present invention provides a configuration for random access channel resources, the procedure of accomplishing the MTC UE access by using the method is as follows, which includes:

(1) In FDD-LTE systems, random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, the prach-ConfigIndex is equivalent to “PRACH Configuration Index” in Table 2, as shown in Table 2, “PreambleFormat”, “System frame number” and “Subframe number” may be known according to the value of the PRACH Configuration Index. Wherein, “PreambleFormat” represents a random access sequence format; “System frame number” represents a system frame number (Even represents an even frame, and Any represents any frame); and “Subframe number” represents a subframe number.

TABLE 2
FDD LTE prach-ConfigIndex resource mapping table

| PRACH | | System | |
|---|---|---|---|
| Configuration | Preamble | frame | Subframe |
| Index | Format | number | number |
| 0 | 0 | Even | 1 |
| 1 | 0 | Even | 4 |
| 2 | 0 | Even | 7 |
| 3 | 0 | Any | 1 |
| 4 | 0 | Any | 4 |
| 5 | 0 | Any | 7 |
| 6 | 0 | Any | 1, 6 |
| 7 | 0 | Any | 2, 7 |
| 8 | 0 | Any | 3, 8 |
| 9 | 0 | Any | 1, 4, 7 |
| 10 | 0 | Any | 2, 5, 8 |
| 11 | 0 | Any | 3, 6, 9 |
| 12 | 0 | Any | 0, 2, 4, 6, |
| | | | 8 |
| 13 | 0 | Any | 1, 3, 5, 7, |
| | | | 9 |
| 14 | 0 | Any | 0, 1, 2, 3, |
| | | | 4, 5, 6, 7, |
| | | | 8, 9 |
| 15 | 0 | Even | 9 |
| 16 | 1 | Even | 1 |
| 17 | 1 | Even | 4 |
| 18 | 1 | Even | 7 |
| 19 | 1 | Any | 1 |
| 20 | 1 | Any | 4 |
| 21 | 1 | Any | 7 |
| 22 | 1 | Any | 1, 6 |
| 23 | 1 | Any | 2, 7 |
| 24 | 1 | Any | 3, 8 |
| 25 | 1 | Any | 1, 4, 7 |
| 26 | 1 | Any | 2, 5, 8 |
| 27 | 1 | Any | 3, 6, 9 |
| 28 | 1 | Any | 0, 2, 4, 6, |
| | | | 8 |
| 29 | 1 | Any | 1, 3, 5, 7, |
| | | | 9 |
| 30 | N/A | N/A | N/A |
| 31 | 1 | Even | 9 |
| 32 | 2 | Even | 1 |
| 33 | 2 | Even | 4 |
| 34 | 2 | Even | 7 |
| 35 | 2 | Any | 1 |
| 36 | 2 | Any | 4 |
| 37 | 2 | Any | 7 |
| 38 | 2 | Any | 1, 6 |
| 39 | 2 | Any | 2, 7 |
| 40 | 2 | Any | 3, 8 |
| 41 | 2 | Any | 1, 4, 7 |
| 42 | 2 | Any | 2, 5, 8 |
| 43 | 2 | Any | 3, 6, 9 |
| 44 | 2 | Any | 0, 2, 4, 6, |
| | | | 8 |
| 45 | 2 | Any | 1, 3, 5, 7, |
| | | | 9 |
| 46 | N/A | N/A | N/A |
| 47 | 2 | Even | 9 |
| 48 | 3 | Even | 1 |
| 49 | 3 | Even | 4 |
| 50 | 3 | Even | 7 |
| 51 | 3 | Any | 1 |
| 52 | 3 | Any | 4 |
| 53 | 3 | Any | 7 |
| 54 | 3 | Any | 1, 6 |
| 55 | 3 | Any | 2, 7 |
| 56 | 3 | Any | 3, 8 |
| 57 | 3 | Any | 1, 4, 7 |
| 58 | 3 | Any | 2, 5, 8 |
| 59 | 3 | Any | 3, 6, 9 |
| 60 | N/A | N/A | N/A |
| 61 | N/A | N/A | N/A |
| 62 | N/A | N/A | N/A |
| 63 | 3 | Even | 9 |

When prach-ConfigIndex=14, by looking up the Table 2, it can be known that the random access sequence format is PreambleFormat=0 (the PRACH resources occupy only 1 Subframe under the format), and the PRACH starting resources, i.e., the PRACH resources in the embodiment of the present invention, are configured in all of Subframes 0˜9 of each Frame.

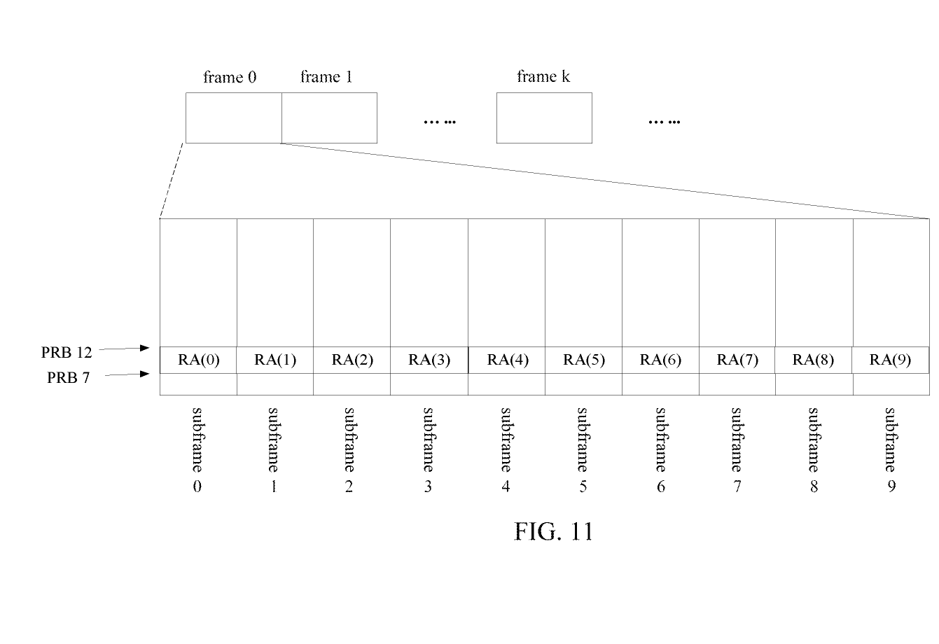

When prach-FreqOffset=7, it is indicated that the minimum PRB index occupied by the PRACH resources in the frequency domain is a PRB7, if 6 PRBs are occupied by the PRACH resources in the frequency domain, then PRB7˜PRB12 in each Subframe in each Frame are configured as the PRACH resources, as shown in FIG. 11.

In the embodiment of the present invention, an LTE UE and an MTC UE simultaneously exist in the FDD-LTE systems, and the PRACH resources used by the LTE UE and the MTC UE are different, the PRACH resources in FIG. 11 are allocated to the MTC UE. The MTC UE is further divided into an MTC UE which does not need coverage improvement (i.e., a Normal MTC UE) and an MTC UE which needs coverage improvement (i.e., a Coverage Improvement MTC UE). The Coverage Improvement MTC UE is further divided into multiple levels, it is divided into 3 levels in the embodiment of the present invention: a Coverage Improvement Level 1, a Coverage Improvement Level 2 and a Coverage Improvement Level 3 respectively, and the division principles are at least one of the following:

divided into multiple levels according to the different coverage improvement levels required to be supported by the Coverage Improvement MTC UE;

divided into multiple levels according to the different numbers of repeated transmissions of the random access sequences required to be supported by the Coverage Improvement MTC UE; and

divided into multiple levels according to the different repeat times of the Physical Broadcast Channel (PBCH) used when the Coverage Improvement MTC UE decodes successfully the PBCH.

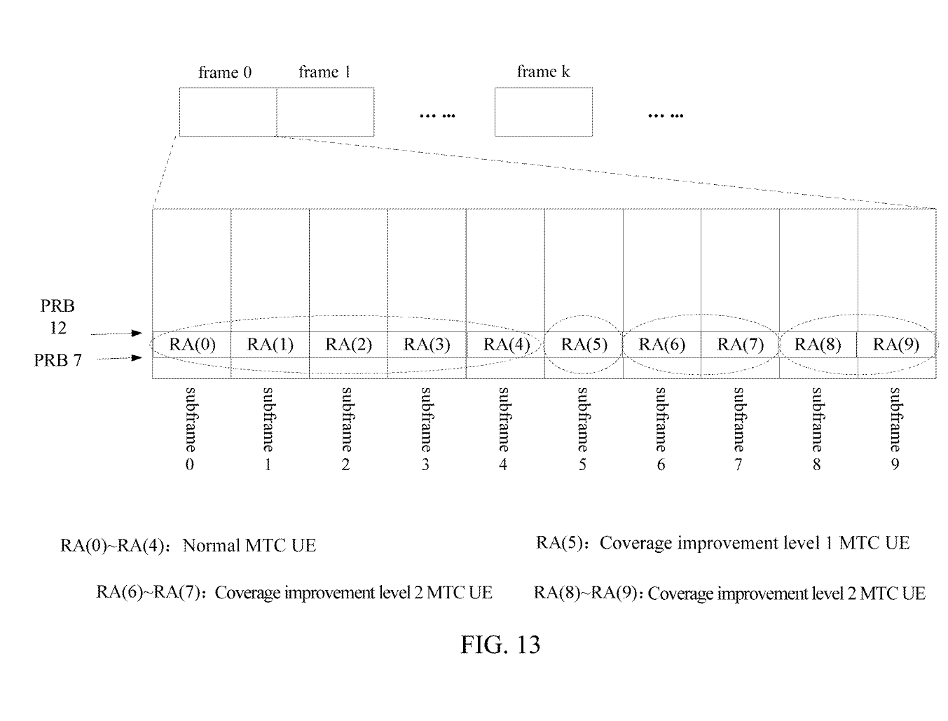

In the embodiment of the present invention, PRACH resources RA(0)˜RA(4) in the Frame 0 are allocated to the Normal MTC UE; RA(5) is allocated to the MTC UE of the Coverage Improvement Level 1; RA(6)˜RA(7) are allocated to the MTC UE of the Coverage Improvement Level 2; and RA(8)˜RA(9) are allocated to the MTC UE of the Coverage Improvement Level 3, as shown in FIG. 12. The PRACH resources are allocated in the similar manner in the Frame 1, Frame 2, . . . Frame k . . . .

Wherein, the random access channel configuration information may be configured in at least one of the flowing:

a System Information Block (SIB);

a Master Information Block (MIB); and

Downlink Control Information (DCI).

Wherein, the random access channel configuration information may be sent in at least one of the flowing:

a Physical Broadcast Channel (PBCH);

a Physical Downlink Control Channel (PDCCH);

an Enhanced Physical Downlink control Channel (PDCCH); and

a Physical Downlink Shared Channel (PDSCH).

(2) The indexes of the starting resources occupied when the MTC UE sends the random access sequences may be obtained in the following manners:

the indexes of the PRACH starting resources allocated to each type of the MTC UE (the Normal MTC UE or the Coverage Improvement Level 1 MTC UE or the Coverage Improvement Level 2 MTC UE or the Coverage Improvement Level 3 MTC UE) are resequenced and then determined based on the following formula:

Start′={RAIdxₖⁱ|mod(RAIdxₖⁱ,RACHRepTimeᵢ)=0},

wherein, RAIdxₖⁱ is the kth resource after the PRACH starting resources of the MTC UE of the type i are resequenced;

i=0 represents the Normal MTC UE; i=1 represents the Coverage Improvement Level 1 MTC UE; i=2 represents the Coverage Improvement Level 2 MTC UE; i=3 represents the Coverage Improvement Level 3 MTC UE;

RACHRepTimeᵢ is the number of the PRACH starting resources included in the resources occupied by the random access signalings sent by the MTC UE of the type i; and

Startⁱ is the index of the PRACH starting resources occupied when the MTC UE of the type i sends the random access sequences.

(3) The MTC UE sends the random access signalings on the allocated random access resources;

(4) After the first nodes receive the random access signalings sent by the MTC UE, the first nodes send random access response signalings to the MTC UE to respond to the random access signalings sent by the MTC UE.

Wherein, the random access response information of one or a plurality of the MTC UEs is carried in the random access response signalings; and the type of the MTC UE of the random access response information may be carried in the same random access response signaling, and it is configured by the system or sent to the MTC UEs by the first nodes.

In the embodiment of the present invention, it is assumed that the random access response information of two MTC UEs such as a UE1 and a UE2 is carried in the random access response signalings, and both the UE1 and the UE2 belong to the Coverage Improvement Level 2, and the repeat times of the random access response signalings corresponding to the Coverage Improvement Level 2 is A, the correspondence relationship described above is configured by the system. Thus the random access response signalings are sent A times repeatedly by the first nodes.

In addition to the embodiment of the present invention, it is assumed that the random access response information of two MTC UEs such as a UE1 and a UE2 is carried in the random access response signalings, and both the UE1 and the UE2 belong to the Coverage Improvement Level 2, and the information of repeat times of the random access response signalings is indicated directly by the downlink control information and is sent to the UE1 and UE2 through the PDCCH or ePDCCH;

In addition to the embodiment of the present invention, it is assumed that the random access response information of two MTC UEs such as a UE1 and a UE2 is carried in the random access response signalings, and the number of repeated transmissions of the random access sequences supported by the UE1 and the UE2 are same, e.g., they are both C times, and the repeat times of the random access response signalings corresponding to the repeat times C of transmission of the random access sequences is A, the correspondence relationship described above is configured by the system; in addition to the embodiment of the present invention, the UE1 and UE2 may also belong to different Coverage Improvement Levels, for example, the UE1 belongs to the Coverage Improvement Level 2, the UE2 belongs to the Coverage Improvement Level 3, and the repeat times of the random access response signalings corresponding to the Coverage Improvement Level 2 is A, and the repeat times of the random access response signalings corresponding to the Coverage Improvement Level 3 is B, for example, B>A, thus the random access response signalings are sent B times repeatedly;

In addition to the embodiment of the present invention, the number of repeated transmissions of the random access sequences supported by the UE1 and UE2 are not same, for example, the number of repetitions of transmission of the random access sequences supported by the UE1 is D and the number of repetitions of transmission of the random access sequences supported by the UE2 is F. The number of repetitions of the random access response signalings corresponding to the number D of repetitions of transmission of the random access sequences is A, and the number of repetitions of the random access response signalings corresponding to the number F of repetitions of transmission of the random access sequences is B, for example, B>A, thus the random access response signalings are sent B times repeatedly;

in addition to the embodiment of the present invention, the maximum number of repetitions of transmission of the PBCH configured by the systems is G, and the number of repetitions of the random access response signalings corresponding to the maximum number G of repetitions of transmission of the PBCH is A, it is assumed that the random access response information of two MTC UEs such as the UE1 and the UE2 is carried in the random access response signalings, the random access response signalings are sent A times repeatedly;

in addition to the embodiment of the present invention, several kinds of numbers of repeated transmissions of the PBCH are configured by the system, for example, they are G1, G2, G3 and G4 respectively, and there is a correspondence relationship between the above number of repeated transmissions of the PBCH and the number of repeated transmissions of the random access response signalings, e.g., G1, G2, G3 and G3 correspond to the repeat times A1, A2, A3 and A4 of transmission of the random access response signalings respectively. It is assumed that the random access response information of two MTC UEs such as the UE1 and the UE2 is carried in the random access response signalings, and when the PBCH is decoded by the UE1 and the UE2, the accumulated repeat times of the PBCH are closest to G1 and G2 respectively; thus the random access response signalings are sent A2 times repeatedly;

in addition to the embodiment of the present invention, several kinds of numbers of repeated transmissions of the PBCH are configured by the system, for example, they are G1, G2, G3 and G4 respectively, and there is a correspondence relationship between the above number of repeated transmissions of the PBCH and the number of repeated transmissions of the random access response signalings, e.g., G1, G2, G3 and G3 correspond to the repeat times A1, A2, A3 and A4 of transmission of the random access response signalings respectively. It is assumed that the random access response information of two MTC UEs such as the UE1 and the UE2 is carried in the random access response signalings, and when the PBCH is decoded by the UE1 and UE2, the accumulated repeat times of the PBCH are all closest to G2; thus the random access response signalings are sent A2 times repeatedly;

in addition to the embodiment of the present invention, the maximum number of repetitions of transmission of the MIB configured by the system is G, and the number of repetitions of the random access response signalings corresponding to the maximum number G of repetitions of transmission of the MIB is A, it is assumed that the random access response information of two MTC UEs such as the UE1 and the UE2 is carried in the random access response signalings, the random access response signalings are sent A times repeatedly;

in addition to the embodiment of the present invention, several kinds of numbers of repeated transmissions of the MIB are configured by the system, for example, they are G1, G2, G3 and G4 respectively, and there is a correspondence relationship between the above number of repeated transmissions of the MIB and the number of repeated transmissions of the random access response signalings, e.g., G1, G2, G3 and G4 correspond to the repeat times A1, A2, A3 and A4 of transmission of the random access response signalings respectively. It is assumed that the random access response information of two MTC UEs such as the UE1 and the UE2 is carried in the random access response signalings, and when the MIB is decoded by the UE1 and UE2, the accumulated repeat times of the MIB are closest to G1 and G2 respectively, thus the random access response signalings are sent A2 times repeatedly;

in addition to the embodiment of the present invention, several kinds of numbers of repeated transmissions of the MIB are configured by the system, for example, they are G1, G2, G3 and G4 respectively, and there is a correspondence relationship between the above number of repeated transmissions of the MIB and the number of repeated transmissions of the random access response signalings, e.g., G1, G2, G3 and G4 correspond to the repeat times A1, A2, A3 and A4 of transmission of the random access response signalings respectively. It is assumed that the random access response information of two MTC UEs such as the UE1 and the UE2 is carried in the random access response signalings, and when the MIB is decoded by the UE1 and UE2, the accumulated repeat times of the MIB are all closest to G2, thus the random access response signalings are sent A2 times repeatedly;

in addition to the embodiment of the present invention, the maximum number of repetitions of transmission of the SIB configured by the system is G, and the number of repetitions of transmission of the random access response signalings corresponding to the maximum number G of repetitions of transmission of the SIB is A, it is assumed that the random access response information of two MTC UEs such as the UE1 and the UE2 is carried in the random access response signalings, the random access response signalings are sent A times repeatedly;

in addition to the embodiment of the present invention, several kinds of numbers of repeated transmissions of the SIB are configured by the system, for example, they are G1, G2, G3 and G4 respectively, and there is a correspondence relationship between the above number of repeated transmissions of the SIB and the number of repeated transmissions of the random access response signalings, e.g., G1, G2, G3 and G4 correspond to the repeat times A1, A2, A3 and A4 of transmission of the random access response signalings respectively. It is assumed that the random access response information of two TC UEs such as the UE1 and the UE2 is carried in the random access response signalings, and when the SIB is decoded by the UE1 and UE2, the accumulated repeat times of the SIB are closest to G1 and G2 respectively, thus the random access response signalings are sent A2 times repeatedly;

in addition to the embodiment of the present invention, several kinds of numbers of repeated transmissions of the SIB are configured by the system, for example, they are G1, G2, G3 and G4 respectively, and there is a correspondence relationship between the above number of repeated transmissions of the SIB and the number of repeated transmissions of the random access response signalings, e.g., G1, G2, G3 and G4 correspond to the repeat times A1, A2, A3 and A4 of transmission of the random access response signalings respectively. It is assumed that the random access response information of two MTC UEs such as the UE1 and the UE2 is carried in the random access response signalings, and when the SIB is decoded by the UE1 and UE2, the accumulated repeat times of the SIB are all closest to G2, thus the random access response signalings are sent A2 times repeatedly;

wherein, the first nodes illustrated are one of the following:

a Macrocell, a Microcell, a Picocell, a Femtocell (also called a home eNode B), a low power node (LPN), a Relay and a Small Cell.

### Embodiment 13 of the Present Invention

The embodiment of the present invention provides a configuration for random access channel resources, the procedure of accomplishing the MTC UE access by using the method is as follows, which includes:

(1) In FDD-LTE systems, random access channel resource configuration information is indicated by one piece of random access channel configuration information, prach-ConfigIndex and prach-FreqOffset are at least contained in the random access channel configuration information.

Wherein, the prach-ConfigIndex is used to describe allocated time domain position information of PRACH starting resources (the time domain length being one subframe) within one predefined time domain length and the number of the PRACH starting resources within the predefined time domain length. A mapping relationship exists between the different values of the prach-ConfigIndex and the position information of the PRACH starting resources within the predefined time domain length and the number of the PRACH starting resources within the predefined time domain length and it is configured by the system. In the embodiment of the present invention, the prach-ConfigIndex is equivalent to “PRACH Configuration Index” in Table 2, as shown in Table 2, “PreambleFormat”, “System frame number” and “Subframe number” may be known according to the value of the PRACH Configuration Index. Wherein, “PreambleFormat” represents a random access sequence format; “System frame number” represents a system frame number (Even represents an even frame, and Any represents any frame); and “Subframe number” represents a subframe number.

When prach-ConfigIndex=14, by looking up the Table 2, it can be known that the random access sequence format is PreambleFormat=0 (the PRACH resources occupy only 1 Subframe under the format), and the PRACH starting resources, i.e., the PRACH resources in the embodiment of the present invention, are configured in all of subframes 0˜9 of each Frame.

When prach-FreqOffset=7, the minimum PRB index n_{PRB}^{RA} occupied by the PRACH resources in the frequency domain within the Frame k can be calculated and obtained based on the prach-FreqOffset;

$${n}_{PRB}^{RA} = \{ \begin{matrix}{n}_{PRB offset}^{RA} , if k mod 2 = 0 \\ {N}_{RB}^{UL} - {N}_{PRB}^{RA} - {n}_{PRB offset}^{RA} , otherwise\end{matrix} ,$$

wherein, the value of n_{PRB offset}^{RA} is described by the prach-FreqOffset, e.g., n_{PRB offset}^{RA}=7;

N_{RB}^{UL} is the magnitude of the uplink system bandwidth with the PRB as a unit, e.g., N_{RB}^{UL}=50;

k is a Frame index number; and

N_{PRB}^{RA} the number of PRBs occupied by the PRACH in the frequency domain, e.g., N_{PRB}^{RA}=6.

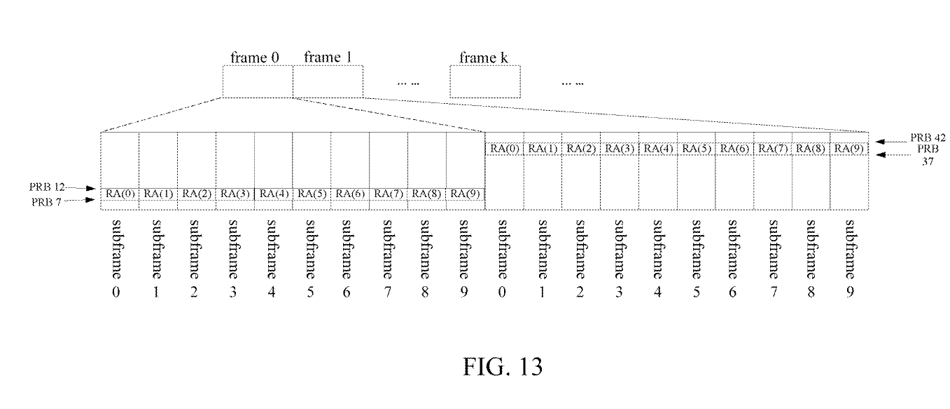

The PRACH resources configuration in each Frame is as shown in FIG. 13, frequency domain resources PRB7˜PRB12 are occupied in the Frame 0, Frame 2, Frame 4, . . . ; frequency domain resources PRB37˜PRB42 are occupied in the Frame 1, Frame 3, Frame 5, . . . .

In the embodiment of the present invention, an LTE UE and an MTC UE simultaneously exist in the FDD-LTE systems, and the PRACH resources used by the LTE UE and the MTC UE are different, the PRACH resources in FIG. 13 are allocated to the MTC UE. The MTC UE is further divided into an MTC UE which does not need coverage improvement (i.e., a Normal MTC UE) and an MTC UE which needs coverage improvement (i.e., a Coverage Improvement MTC UE). The Coverage Improvement MTC UE is further divided into multiple levels, it is divided into 3 levels in the embodiment of the present invention: a Coverage Improvement Level 1, a Coverage Improvement Level 2 and a Coverage Improvement Level 3 respectively, and the division principles are at least one of the following:

divided into multiple levels according to the different coverage improvement levels required to be supported by the Coverage Improvement MTC UE;

divided into multiple levels according to the different numbers of repeated transmissions of the random access sequences required to be supported by the Coverage Improvement MTC UE; and

divided into multiple levels according to the different repeat times of the Physical Broadcast Channel (PBCH) used when the Coverage Improvement MTC UE decodes successfully the PBCH.

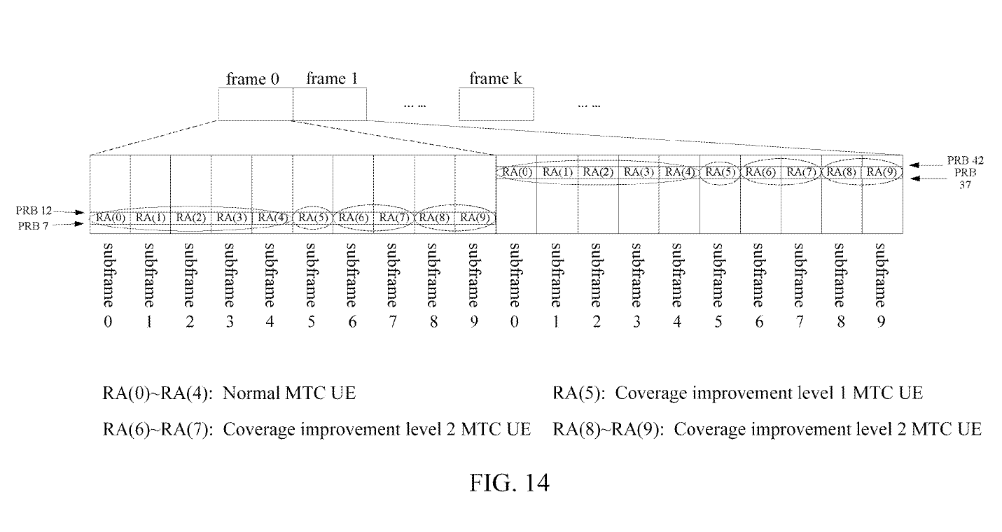

In the embodiment of the present invention, PRACH resources RA(0)˜RA(4) in the Frame 0 are allocated to the Normal MTC UE; RA(5) is allocated to the MTC UE of the Coverage Improvement Level 1; RA(6)˜RA(7) are allocated to the MTC UE of the Coverage Improvement Level 2; and RA(8)˜RA(9) are allocated to the MTC UE of the Coverage Improvement Level 3, as shown in FIG. 14. The PRACH resources are allocated in the similar manner in the Frame 1, Frame 2, . . . Frame k . . . .

Wherein, the random access channel configuration information may be configured in at least one of the following:

a System Information Block (SIB);

a Master Information Block (MIB); and

Downlink Control Information (DCI).

Wherein, the random access channel configuration information may be sent in at least one of the following:

a Physical Broadcast Channel (PBCH);

a Physical Downlink Control Channel (PDCCH); and

a Physical Downlink Shared Channel (PDSCH).

(2) The indexes of the starting resources occupied when the MTC UE sends the random access sequences may be obtained in the following manners:

the indexes of the PRACH starting resources allocated to each type of the MTC UE (the Normal MTC UE or the Coverage Improvement Level 1 MTC UE or the Coverage Improvement Level 2 MTC UE or the Coverage Improvement Level 3 MTC UE) are resequenced and then determined based on the following formula:

Startⁱ={RAIdxₖⁱ|mod(RAIdxₖⁱ,RACHRepTimeᵢ)=0},

wherein, RAIdxₖⁱ is the kth resource after the PRACH starting resources of the MTC UE of the type i are resequenced;

i=0 represents the Normal MTC UE; i=1 represents the Coverage Improvement Level 1 MTC UE; i=2 represents the Coverage Improvement Level 2 MTC UE; i=3 represents the Coverage Improvement Level 3 MTC UE;

RACHRepTimeᵢ is the number of the PRACH starting resources included in the resources occupied by the random access signalings sent by the MTC UE of the type i; and

Startⁱ is the index of the PRACH starting resources occupied when the MTC UE of the type i sends the random access sequences.

(3) The MTC UE sends the random access signalings on the allocated random access resources;

(4) After the first nodes receive the random access signalings sent by the MTC UE, the first nodes send random access response signalings to the MTC UE to respond to the random access signalings sent by the MTC UE.

Wherein, the random access response information of one or a plurality of the MTC UEs is carried in the random access response signalings; and the type of the MTC UE of the random access response information may be carried in the same random access response signaling, and it is configured by the system or sent to the MTC UE by the first nodes.

In the embodiment of the present invention, it is assumed that the random access response information of two MTC UEs such as the UE1 and the UE2 is carried in the random access response signalings, and both the UE1 and the UE2 belong to the Coverage Improvement Level 2.

In addition to the embodiment of the present invention, the UE1 and UE2 may also belong to different Coverage Improvement Levels, but need to be predefined by the system.

Wherein, the first nodes illustrated are one of the following:

a Macrocell, a Microcell, a Picocell, a Femtocell (also called a home eNode B), a low power node (LPN), a Relay and a Small Cell.

### Embodiment 14 of the Present Invention

In the embodiment of the present invention, a system for configuring random access channel resources includes first nodes and second nodes;

the first nodes are used to send random access channel resource configuration information to the second nodes, the random access channel resource configuration information contains indications of one or a plurality of pieces of random access channel configuration information.

Preferably, the second nodes are one or a plurality of terminals or one or a plurality of terminal groups.

Preferably, the first nodes are at least one of the following:

a Macrocell, a Microcell, a Picocell, a home eNode B, an LPN, a Relay and a Small Cell.

Preferably, the second nodes are used to determine the corresponding random access channel resources according to the random access channel configuration information and send the random access signalings to the first nodes by using the random access channel resources;

the first nodes are also used to send random access response signalings to the second nodes to respond to the random access signalings sent by the second nodes.

The system for configuring random access channel resources provided by the embodiment of the present invention can be combined with a method for configuring random access channel resources provided by the embodiment of the present invention to implement access of the MTC UE in the LTE/A-LTE systems.

The ordinary people skilled in the art may understand that all or part of steps in the embodiments described above can be implemented through flows of the computer programs, and the computer programs can be stored in a computer readable storage medium. The computer programs are executed on the corresponding hardware platforms (such as a system, device, apparatus and component, etc.), and during the execution, one or a combination of the steps in the method embodiments are included.

Optionally, all or part of the steps in the embodiments described above also can be implemented by using integrated circuits. These steps can be made into a plurality of integrated circuit modules respectively or a plurality of modules or steps of them can be made into a single integrated circuit to be implemented. Thus, the present document is not limited to any combination of hardware and software in a specific form.

Various apparatuses/functional modules/functional units in the embodiments described above, which can be implemented by using general computing apparatuses, can be centralized on a single computing apparatus or distributed on a network formed from a plurality of computing apparatus.

Various apparatuses/functional modules/functional units in the embodiments described above, when implemented in a form of software functional module and sold or used as stand-stone products, can be stored in a computer readable storage medium. The computer readable storage medium mentioned above may be a read-only memory, magnetic disk or optical disk, etc.

Variations or substitutions which may be conceived easily by any person skilled in the art within the technical scope disclosed by the present document should be all covered within the protect scope of the present document. Therefore, the protect scope of the present document should be subject to the protect scope described by the claims.

### INDUSTRIAL APPLICABILITY

The embodiments of the present invention provide a method and system for configuring random access channel resources, the first nodes send random access channel resource configuration information to the second nodes, the random access channel resource configuration information contains indications of one or a plurality of pieces of random access channel configuration information, which indicates that the random access channel resources for the second nodes sending the random access signalings, thereby implementing the random access channel resource configuration of the MTC UE in the LTE/LTE-A systems and solving the problem of access of the MTC UE in the LTE/LET-A systems.

What is claimed is:

1. A method for configuring random access channel resources, comprising:
first nodes sending random access channel resource configuration information to second nodes, wherein the random access channel resource configuration information is indicated by one or a plurality of pieces of random access channel configuration information.

2. The method for configuring the random access channel resources according to claim 1, wherein, configuration information of first resources is at least comprised in the random access channel configuration information, the first resources are one of the following:
resources used for sending random access signalings and allocated to the second nodes; and
starting resources used for sending the random access signalings and allocated to the second nodes.

3. The method for configuring the random access channel resources according to claim 2, wherein,
the first resources occupy one or a plurality of first time domain measurement units in a time domain and occupy one or a plurality of first frequency domain measurement units in a frequency domain.

4-5. (canceled)

6. The method for configuring the random access channel resources according to claim 3, wherein, the configuration information of the first resources comprises at least one of the following:
configuration index information of the first resources; and
frequency domain offset information of the first resources.

7. The method for configuring the random access channel resources according to claim 6, wherein, the configuration index information of the first resources indicates any one or a plurality of pieces of the following information:
within a predefined time domain period, time domain position distribution information occupied by the first resources within the predefined time domain period, wherein the predefined time domain period is described by using the first time domain measurement units and is configured by a system or sent by the first nodes;
quantity information of the first resources within a predefined time domain period, wherein the predefined time domain period is described by using the first time domain measurement units and is configured by a system or sent by the first nodes;
format information of the random access signalings;
information of whether the first resources support frequency hopping; and
frequency hopping pattern information of the first resources.

8. (canceled)

9. The method for configuring the random access channel resources according to claim 6, wherein, position information of the first resources in the frequency domain is determined by the frequency domain offset information of the first resources;
or
position information of the first resources in the frequency domain is at least one of the following:
information of a starting resource position of the first resources in the frequency domain;
information of an end resource position of the first resources in the frequency domain; and
information of an occupied resource position of the first resources in the frequency domain.

10-11. (canceled)

12. The method for configuring the random access channel resources according to claim 6, wherein, frequency domain position distribution information of the first resources is determined by the frequency domain offset information of the first resources and the configuration index information of the first resources,
preferably, there are a plurality of positions of the first resources in the frequency domain,
more preferably, positions of a plurality of the first resources in a same time domain position are different in the frequency domain.

13-14. (canceled)

15. The method for configuring the random access channel resources according to claim 6, wherein, the random access channel configuration information further comprises:
frequency domain position distribution spacing information of the first resources,
preferably, frequency domain position distribution information of the first resources is determined by the frequency domain offset information of the first resources, the frequency domain position distribution spacing information of the first resources and the configuration index information of the first resources.

16. (canceled)

17. The method for configuring the random access channel resources according to claim 1, wherein, when the random access channel resource configuration information is indicated by a plurality of pieces of random access channel configuration information, configuration information of first resources comprised in each piece of the random access channel configuration information is different.

18. The method for configuring the random access channel resources according to claim 6, wherein, the random access channel resources are divided into one or a plurality of random access channel resource subsets, the random access channel resources are multiplexed between the random access channel resource subsets by means of time division multiplexing and/or frequency division multiplexing and/or code division multiplexing.

19. The method for configuring the random access channel resources according to claim 18, wherein, when the random access channel resources are multiplexed between the random access channel resource subsets by means of time division multiplexing:
first resources whose time domain positions are within a predefined time domain set in the first resources are allocated to a random access channel resource subset; or,
first resources whose time domain positions are within a predefined time domain set and which have same frequency domain positions in the first resources are allocated to a random access channel resource subset; or,
first resources whose time domain positions are within a predefined time domain set and which are at predefined frequency domain positions in the first resources are allocated to a random access channel resource subset,
preferably, the predefined time domain set comprises one or a plurality of time domain time points, and the time domain time points are measured by the first time domain measurement units, and the one or the plurality of time domain time points are distributed continuously or discretely in a time domain,
more preferably, the predefined frequency domain positions are required to meet the following conditions:
frequency domain positions of the first resources on two adjacent time domain time points are different; and/or,
there are N different types of frequency domain positions among the predefined frequency domain positions, and the predefined time domain set is divided into N subsets, the frequency domain positions of the first resources in each subset correspond to one of the predefined frequency domain positions, N is an integer greater than or equal to 1.

20-21. (canceled)

22. The method for configuring the random access channel resources according to claim 18, wherein, when the random access channel resources are multiplexed between the random access channel resource subsets by means of frequency division multiplexing,
first resources whose frequency domain positions are within a predefined frequency domain set in the first resources are allocated to a random access channel resource subset; or,
first resources whose frequency domain positions are within a predefined frequency domain set and which are at predefined time domain positions in the first resources are allocated to a random access channel resource subset,
preferably, the predefined frequency domain set comprises one or a plurality of frequency domain points, and the frequency domain points are measured by the first frequency domain measurement units, the one or the plurality of frequency domain points are distributed continuously or discretely in a frequency domain;
or
the predefined time domain positions comprise one or a plurality of time domain time points, and the time domain time points are measured by the first time domain measurement units, the one or the plurality of time domain time points are distributed continuously or discretely in a time domain.

23-24. (canceled)

25. The method for configuring the random access channel resources according to claim 18, wherein, when the random access channel resources are multiplexed between the random access channel resource subsets by means of time division multiplexing and frequency division multiplexing, the first resources within a predefined set are allocated to a random access channel resource subset,
preferably, elements in the predefined set are one or a plurality of sequenced first resources,
more preferably, a sequencing rule of the first resources is configured by the system.

26-27. (canceled)

28. The method for configuring the random access channel resources according to claim 18, wherein, when the random access channel resources are multiplexed between the random access channel resource subsets by means of code division multiplexing,
a random access channel resource subset is formed from at least one predefined random access sequence set.

29. The method for configuring the random access channel resources according to claim 28, wherein, one or a plurality of random access sequences are contained in the predefined random access sequence set.

30. The method for configuring the random access channel resources according to claim 28, wherein, the random access channel resource subset supports one type or a plurality of types of the second nodes to transmit the random access sequences,
preferably, the types of the second nodes are divided according to one of the following principles:
coverage improvement levels required to be supported by the second nodes,
the number of repeated transmissions of the random access sequences required to be supported by the second nodes,
repeat times of a physical broadcast channel (PBCH) used when the PBCH is decoded successfully by the second nodes,
repeat times of a master information block (MIB) message when the MIB message is decoded successfully by the second nodes,
repeat times of a system information block (SIB) message when the SIB message is decoded successfully by the second nodes, and
repeat times of the MIB message when the PBCH is decoded successfully by the second nodes,
more preferably, the second nodes are one or a plurality of terminals or one or a plurality of terminal groups.

31-32. (canceled)

33. The method for configuring the random access channel resources according to claim 7, wherein, the first nodes are at least one of the following:
a Macrocell, a Microcell, a Picocell, a Femtocell, a low power node (LPN), a Relay and a Small Cell.

34. The method for configuring the random access channel resources according to claim 7, after the step of the first nodes sending random access channel resource configuration information to the second nodes, further comprising:
the second nodes determining corresponding random access channel resources according to the random access channel configuration information and sending random access signalings to the first nodes by using the random access channel resources.

35. The method for configuring the random access channel resources according to claim 34, after the step of the second nodes determining the corresponding random access channel resources according to the random access channel configuration information and sending the random access signalings to the first nodes by using the random access channel resources, further comprising:
the first nodes sending random access response signalings to the second nodes to respond to the random access signalings sent by the second nodes.

36. The method for configuring the random access channel resources according to claim 35, wherein, random access response information of one or a plurality of the second nodes is carried in the random access response signalings.

37. The method for configuring the random access channel resources according to claim 36, wherein, the one or the plurality of the second nodes are configured by the system or the first nodes;
or
the one or the plurality of the second nodes have any one or a plurality of the following properties:
the one or the plurality of the second nodes belong to the same type,
coverage improvement levels required to be supported by the one or the plurality of the second nodes are same,
the number of repeated transmissions of the random access sequences required to be supported by the one or the plurality of the second nodes are same, and
RA-RNTIs calculated by the one or the plurality of the second nodes are same;
or
the types of the one or the plurality of the second nodes are configured by a system;
the coverage improvement levels required to be supported by the one or the plurality of the second nodes are configured by the system; and
the number of repeated transmissions of the random access sequences required to be supported by the one or the plurality of the second nodes are configured by the system.

38-39. (canceled)

40. The method for configuring the random access channel resources according to claim 35, wherein, information of the number of repeated transmissions of the random access response signalings is indicated by the first nodes,
preferably, the first nodes indicate the information of the number of repeated transmissions of the random access response signalings in at least one of the following manners:
indicating the information of the number of repeated transmissions of the random access response signalings in downlink control information;
a mapping relationship existing between information of maximum repeat times supported by a PBCH sent by the first nodes and the information of the number of repeated transmissions of the random access response signalings;
a mapping relationship existing between information of maximum repeat times supported by MIB information sent by the first nodes and the information of the number of repeated transmissions of the random access response signalings;
a mapping relationship existing between information of maximum repeat times supported by SIB information sent by the first nodes and the information of the number of repeated transmissions of the random access response signalings;
a mapping relationship existing between information of repeat times supported by the PBCH and the information of the number of repeated transmissions of the random access response signalings;
a mapping relationship existing between information of repeat times supported by the MIB and the information of the number of repeated transmissions of the random access response signalings; and
a mapping relationship existing between information of repeat times supported by the SIB and the information of the number of repeated transmissions of the random access response signalings;
or
the information of the number of repeated transmissions of the random access response signalings is indicated by the types of the second nodes or the coverage improvement levels or the supported number of repeated transmissions of the random access sequences.

41-42. (canceled)

43. A system for configuring random access channel resources, comprising first nodes and second nodes; wherein,
the first nodes are configured to: send random access channel resource configuration information to the second nodes, wherein the random access channel resource configuration information contains indications of one or a plurality of pieces of random access channel configuration information.

44. The system for configuring the random access channel resources according to claim 43, wherein, the second nodes are one or a plurality of terminals or one or a plurality of terminal groups.

45-46. (canceled)
